(19) United States
(12) Patent Application Publication
(10) Pub. No.: US 2025/0038828 A1
(43) Pub. Date: Jan. 30, 2025

(54) BEAM INDICATION FOR 5G NEW RADIO

(71) Applicant: INTERDIGITAL PATENT HOLDINGS, INC., Wilmington, DE (US)

(72) Inventors: Fengjun Xi, San Diego, CA (US); Wei Chen, San Diego, CA (US); Kyle Jung-Lin Pan, Saint James, NY (US); Chunxuan Ye, San Diego, CA (US)

(73) Assignee: INTERDIGITAL PATENT HOLDINGS, INC., Wilmington, DE (US)

(21) Appl. No.: 18/916,206

(22) Filed: Oct. 15, 2024

Related U.S. Application Data
(63) Continuation of application No. 17/044,384, filed on Oct. 1, 2020.
(60) Provisional application No. 62/753,679, filed on Oct. 31, 2018.
(60) Provisional application No. 62/716,044, filed on Aug. 8, 2018.
(60) Provisional application No. 62/652,700, filed on Apr. 4, 2018.

(51) Int. Cl. H04B 7/08; H04L 5/00; H04W 72/044

(52) U.S. Cl. CPC H04B 7/088; H04L 5/0053; H04W 72/046

(57) ABSTRACT

A wireless transmit/receive unit (WTRU) may receive sounding reference signal (SRS) resource configuration information. The WTRU may also receive beam indication (ID) information and panel ID information in downlink control information (DCI) and determine a WTRU panel based on the panel ID information or the SRS resource configuration information. The WTRU may also determine uplink (UL) beam sweeping for each determined WTRU panel based on the beam ID using one or more sweeping parameters.

### CROSS-REFERENCE TO RELATED APPLICATIONS

This application is a continuation of U.S. patent application Ser. No. 17/044,384 filed on Oct. 1, 2020 which claims priority to PCT/US2019/025746 filed on Apr. 4, 2019 which claims the benefit of U.S. Provisional Application No. 62/753,679, filed Oct. 31, 2018, U.S. Provisional Application No. 62/716,044, filed Aug. 8, 2018, and U.S. Provisional Application No. 62/652,700, filed Apr. 4, 2018, the contents of which are incorporated herein by reference.

### BACKGROUND

For mobile communications, downlink (DL) beam management (BM) may be utilized. Beam correspondence may also be configured as a wireless transmit/receive unit (WTRU) capability in new radio (NR), 5G, or the like. A WTRU may determine a transmit (TX) beam based on the determined receive (RX) beam from DL BM. Uplink (UL) BM may be unnecessary when optimal or perfect beam correspondence is fulfilled at both the transmit-receive point (TRP) and the WTRU.

For imperfect WTRU beam correspondence, full or global beam sweeping may be utilized to identify the optimal or best UL TX beam from all or most WTRU TX beams. However, using full beam sweeping may be inefficient for UL BM due to large training overhead. Training may be undesirable due to high latency, high power consumption, additional processing time, or the like. Partial or local beam sweeping may be utilized since it may require a smaller amount of resources to train neighbor beams. However, partial or local beam sweeping may also sometimes be insufficient or undesirable.

### SUMMARY

Sounding reference signal (SRS) beam indication for uplink (UL) beam management or beam sweeping, beam indication for multiple bandwidth parts (BWPs), or beam indication for multiple transmit-receive points (TRPs) may be configured for low latency and efficient beam indication. The beam indication for multiple BWPs may further include a beam indication for multiple downlink (DL) BWPs, a beam indication for multiple UL BWPs, a beam indication for UL and DL BWPs, or the like.

A wireless transmit/receive unit (WTRU) may also be configured to receive a SRS configuration message indicating spatial relationship information for each SRS resource of a plurality of SRS resources. The WTRU may determine at least a spatial domain transmission filter or an UL beam(s) for each SRS resource based on the spatial relationship information associated with each SRS resource and transmit each SRS resource with the determined spatial domain transmission filter or determined UL beam(s). A WTRU may also receive configuration information for at least one of multiple DL BWPs or multiple UL BWPs.

A WTRU may be configured for independent or joint beam indication for multiple TRPs. For independent beam indication, the WTRU may receive configuration information including a SRS beam indication from multiple TRPs and transmit using a SRS resource to each of the multiple TRPs on an associated UL beam(s) based on the received configuration information. For joint beam indication, the WTRU may receive configuration information from a lead TRP that includes a SRS beam indication for the lead and multiple TRPs. The WTRU may transmit using a SRS resource to each of the multiple TRPs on an associated UL beam(s) based on the received configuration information.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a transmit-receive point (TRP) and WTRU antenna model;

FIG. 3 is a table with examples of baseline massive antenna configurations for dense urban and urban macro environments;

FIG. 4 illustrates an example of full sweeping and local sweeping for a U-3 procedure;

FIG. 5 is a table with examples of spatial relations between a downlink (DL) reference signal(s) (RS) and an uplink (UL) sounding reference signal(s) (SRS) transmit (TX) beam(s);

FIG. 6 illustrates an example of signaling for beam management (BM);

FIG. 7 illustrates another example of signaling for BM;

FIG. 8 illustrates another example of signaling for BM;

FIG. 9 illustrates an example of downlink control information (DCI)/transmission configuration indicator (TCI) for beam indication for multiple DL bandwidth parts (BWPs);

FIG. 10 is a table with examples of TCI beam indication for multiple DL BWPs;

FIG. 11 is a table with examples of a hybrid solution for beam indication for multiple DL BWPs;

FIG. 12 illustrates an example of utilizing DCI or TCI for SRS beam indication for BM across multiple UL BWPs;

FIG. 13 is a table with examples of a TCI table based configuration for beam indication for multiple DL and UL BWPs

FIG. 14 is a table with examples of association of the SRS resource with a spatial domain transmission filter;

FIG. 15 illustrates an example of a WTRU U-3 sweeping range;

FIG. 16 illustrates another example of a WTRU U-3 sweeping range;

FIG. 17 illustrates an example of an implicit procedure for WTRU U-3 sweeping range determination;

FIG. 18 illustrates an example of a procedure for a WTRU to determine a sweeping beam(s) for triggered SRS resources for UL BM;

FIG. 19 illustrates an example of optimal WTRU beam(s) indication;

FIG. 20 illustrates another example of optimal WTRU beam(s) indication;

FIG. 21 illustrates another example of optimal WTRU beam(s) indication;

FIG. 22 illustrates an example of independent physical uplink shared channel (PUSCH) beam indication and joint PUSCH beam indication;

FIG. 23 illustrates an example of panel specific SRS association;

FIG. 24 illustrates an example of SRS resource association based beam indication for PUSCH transmission;

FIG. 25 illustrates an example of using TCI states for beam indication for a physical uplink control channel (PUCCH) or PUSCH;

FIG. 26 is a table with examples of TCI entries for beam indication for PUCCH or PUSCH in relation with FIG. 25; and

FIG. 27 is a procedure for determining triggered WTRU panels and beams for UL BM.

### DETAILED DESCRIPTION

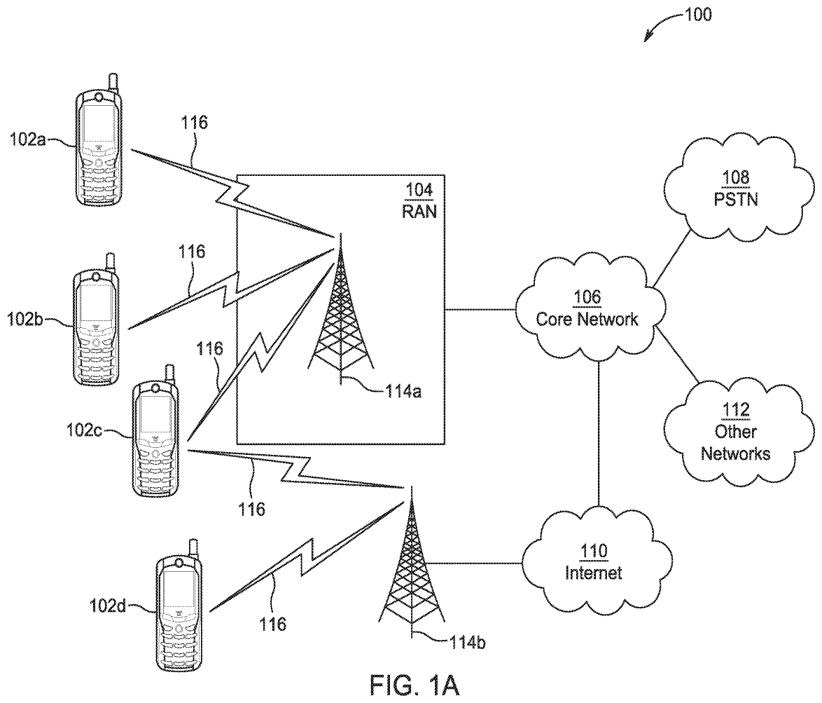

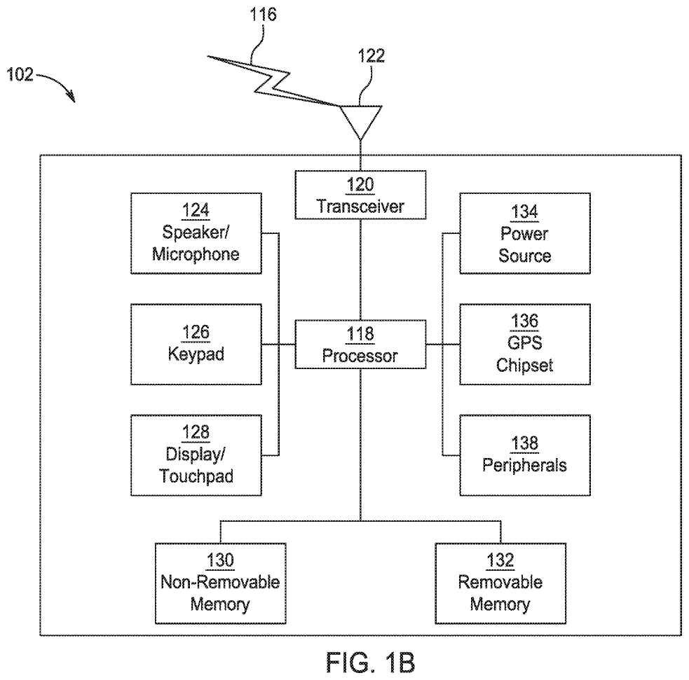

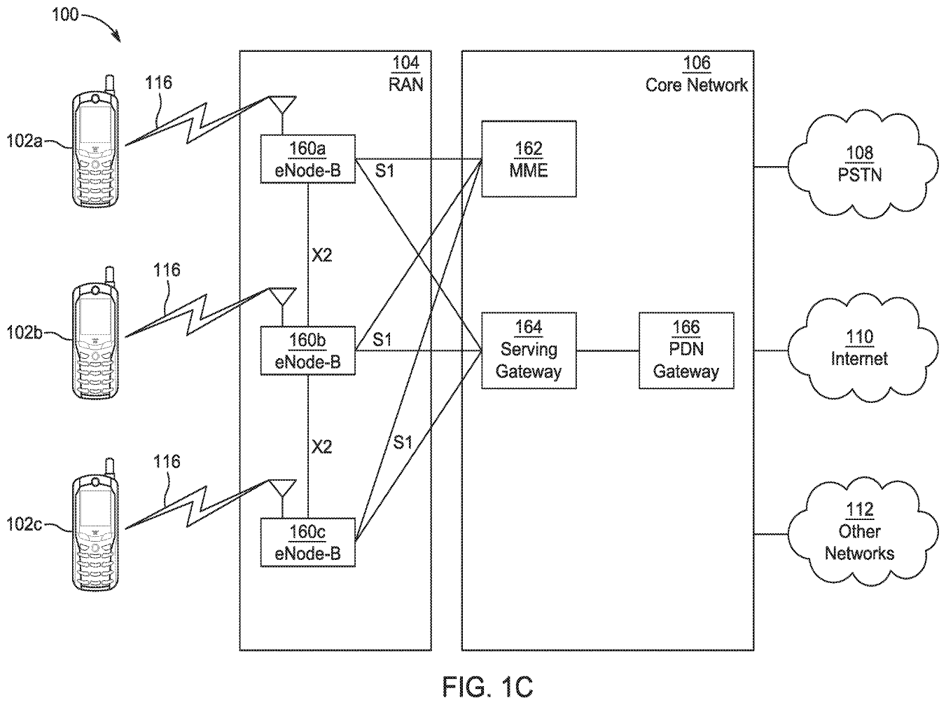

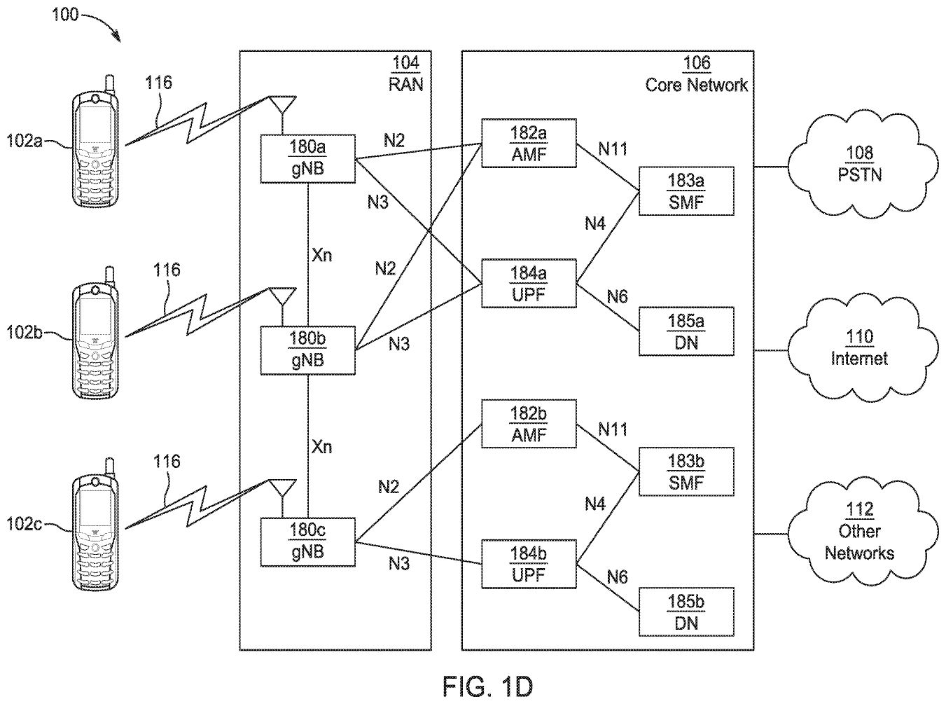

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), user terminal (UT), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Wi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications system 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a next generation nodeb (gNB), a new radio (NR) NodeB, a transmit-receive point (TRP), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, or the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (W-CDMA). W-CDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or communications sent to/from multiple types of base stations (e.g., an eNB and a gNB).

In other embodiments, the base station 114a and the WTRUs 102a, 102b, 102c may implement radio technologies such as Institute of Electrical and Electronics Engineers (IEEE) 802.11 (i.e., Wireless Fidelity (Wi-Fi), IEEE 802.16 (i.e., Worldwide Interoperability for Microwave Access (WiMAX)), cdma2000, cdma2000 1×, cdma2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., W-CDMA, cdma2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The other networks 112 may include wired and/or wireless communication networks owned and/or operated by other service providers. For example, the other networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, a humidity sensor, or the like.

The WTRU 102 may include a full duplex radio for which transmission and reception of some or all of the signals (e.g., associated with particular subframes for both the UL (e.g., for transmission) and DL (e.g., for reception) may be concurrent, simultaneous, or the like. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or W-CDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other networks 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may also be referred to as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 megahertz (MHz) wide bandwidth) or a dynamically set width set via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHz, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, or time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 gigahertz (GHz) modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communication (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy due to a STA, such as a 1 MHz operating mode STA transmitting to the AP, whole frequency bands may be considered busy even though a majority of frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. Also, in an example, gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple CCs (not shown) to the WTRU 102a. A subset of these CCs may be on unlicensed spectrum while the remaining CCs may be on licensed spectrum. In an embodiment, the gNBs 180a, 180b, 180c may implement Coordinated Multi-Point (COMP) technology. For example, WTRU 102a may receive coordinated communications from gNB 180a and gNB 180b (and/or gNB 180c).

The WTRUs 102a, 102b, 102c may communicate with gNBs 180a, 180b, 180c using communications associated with a scalable numerology. For example, the OFDM symbol spacing and/or OFDM subcarrier spacing (SCS) may vary for different communications, different cells, and/or different portions of the wireless communication spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced massive mobile broadband (eMBB) access, services for MTC access, or the like. The AMF 182a, 182b may provide a control plane function for switching between the RAN 104 and other RANs (not shown) that employ other radio technologies, such as LTE, LTE-A, LTE-A Pro, and/or non-third generation partnership project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing UL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In next generation mobile communications, eMBB, massive machine type communications (mMTC), URLLC, or the like are possible deployments in spectrum bands ranging from 700 MHz to 80 GHz. Next generation mobile may utilize either or both licensed and unlicensed spectrum.

For sub-6 GHz transmission, multiple antenna techniques such as multiple input multiple output (MIMO), single input multiple output (SIMO), multiple input single output (MISO), or the like are possible deployments. Multiple antenna techniques may provide diversity gain, multiplexing gain, beamforming, array gain, or the like. In addition, if multiple WTRUs communicate with a single central node, multi-user MIMO (MU-MIMO) may increase system throughput by facilitating the transmission of multiple data streams to different WTRUs at the same time on the same and/or overlapping set of resources in time and/or frequency. For single user MIMO (SU-MIMO), the same central node may transmit multiple data streams to the same WTRU rather than multiple WTRUs as in MU-MIMO.

Multiple antenna transmission at millimetre wave (mmWave) frequencies may differ slightly from sub-6 GHz multiple antenna techniques. This is may be due to the different propagation characteristics at mmWave frequencies and the possibility of the network node or WTRU having a less number of RF chains than antenna elements.

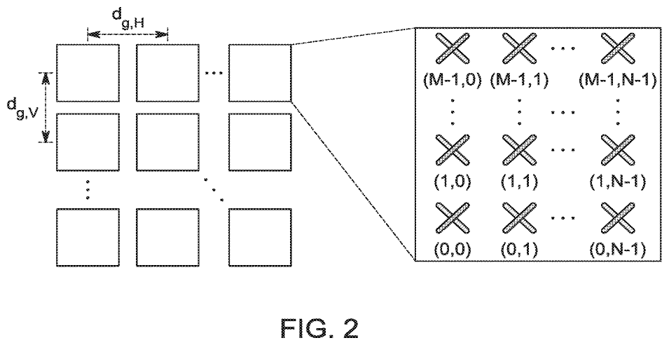

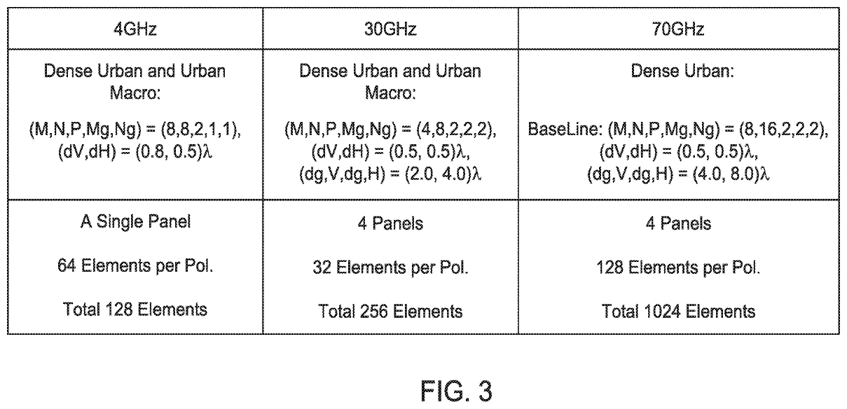

FIG. 2 illustrates an example of a TRP and WTRU antenna model. A massive antenna model may be configured as Mg antenna panels per vertical dimension and Ng antenna panels per horizontal dimension. Each antenna panel may be configured with or without polarization. Each panel may comprise a different array of elements or have one or more beams. The timing and phase may be not calibrated across panels, although multiple panels may be equipped in the same network device, network node, base station, or the like. The baseline massive antenna configuration may be different according to the operating frequency band as shown in the examples in FIG. 3.

Precoding at mmWave frequencies may be digital, analog, a hybrid of digital and analog, or the like. Digital precoding is precise and may be combined with equalization. Digital encoding may configured as SU, MU, multi-cell precoding, or the like in sub 6 GHz frequencies. In mmWave frequencies, a limited number of RF chains compared to antenna elements and the sparse nature of the channel may create challenges for digital beamforming. Analog beamforming may overcome the limited number of RF chains issue by using analog phase shifters on each antenna element. It may be used in IEEE 802.11ad during the sector level sweep to identify the optimal sector, beam refinement to refine the sector to an antenna beam, and beam tracking to adjust the sub-beams over time based on channel changes.

In hybrid beamforming, the precoder may utilize analog and digital domains. Each domain may use precoding and combine matrices with different structural constraints, e.g., constant modulus constraint for combining matrices in the analog domain. As a result, a tradeoff between hardware complexity and system performance may exist. Hybrid beamforming may be able to achieve digital precoding performance due to sparse channel properties and utilize multi-user or multi-stream multiplexing. However, with a limited by number of RF chains it may be undesirable for configurations outside of mmWave.

In LTE, sounding reference signal (SRS) may be a reference signal (RS) transmitted by the WTRU in the UL direction for a network node, such as eNodeB, to estimate the UL channel quality over a wider bandwidth. The network node may use this information for UL frequency selective scheduling, UL timing estimation, or the like. Single SRS, periodic SRS, aperiodic SRS, or the like may be utilized. Single SRS and periodic SRS transmissions may be classified as trigger type 0 SRS transmissions that may be configured by higher layer, radio resource control (RRC), or the like signaling. Aperiodic SRS transmission may be classified as a trigger type 1 SRS transmission that may be configured by RRC but triggered by downlink control information (DCI). The network may configure the WTRU with a WTRU-specific SRS configuration. WTRU specific SRS configuration may provide time domain resources, subframe resources, frequency domain resources, or the like indicated with wide band SRS on the entire bandwidth of interest, narrow band SRS allowing the WTRU to do frequency hopping between transmissions, or the like.

Different WTRUs may have different SRS bandwidths. Each SRS bandwidth may be a multiple of four resource blocks (RBs). Different WTRUs may be configured with the same comb, but with different cyclic shifts or phase rotations, so that SRS transmissions are orthogonal to each other over a similar frequency span. Different WTRUs may utilize various combs to allow for frequency multiplexing with a different frequency span.

In LTE, the power control of SRS may be determined by:

$${P}_{SRS} = min \{ {P}_{CMAX , C} , {P}_{0 PUSCH} + α . P {L}_{DL} + 10. {log}_{10} ( {M}_{SRS} ) + δ + {P}_{SRS} \} . \qquad Equation 1$$

where M_{SRS} is the bandwidth of SRS transmissions, expressed as number of RBs, and P_{SRS} at the end of the equation is a configurable offset. Therefore, SRS transmit power may be based on the bandwidth of the SRS transmission and with an additional power offset.

BM may utilize higher band frequencies. At high frequencies, a channel may experience higher path losses and more abrupt changes. In high frequencies, a large-scale antenna array could be used to achieve high beamforming gain so as to compensate the high propagation loss. The resulting coupling loss could be kept at high level to support the desired data throughput or coverage. Directional beam(s) based communication configurations require accurate beam pairing. An optimal beam(s) direction may be associated with the real channel, in terms of angle of arrival and angle of departure in both azimuth and elevation. An optimal beam(s) direction may be dynamically adjusted with a changing channel.

DL and UL BM procedures may include P-1, P-2, P-3, U-1, U-2, and U-3. For P-1, a WTRU may measure different TRP TX beam(s) for selection of a TRP TX beam(s) and a WTRU RX beam(s). For beamforming at the TRP, an intra/inter-TRP TX sweep from a set of different beams may be performed. For beamforming at the WTRU, a WTRU RX beam sweep from a set of different beams may be performed. A TRP TX beam(s) and a WTRU RX beam(s) may be determined jointly or sequentially.

For P-2, a WTRU may measure on a different TRP TX beam(s) to possibly change an inter/intra-TRP TX beam(s). This configuration may be utilized from a possibly smaller set of beams for beam refinement than in P-1. In addition, for certain configurations P-2 may be a special case or sub class of P-1. For P-3, a WTRU may measure on the same TRP TX beam(s) to change the WTRU RX beam(s) with beamforming.

A U-1 procedure may utilize TRP measurement on different WTRU TX beams for selection of a WTRU TX beam(s) or TRP RX beam(s). A U-2 procedure may utilize TRP measurement on different TRP RX beams to possibly change or select an inter/intra-TRP RX beam(s). A U-3 procedure may utilize TRP measurement on the same TRP RX beam(s) to change the WTRU TX beam(s) in the case WTRU uses beamforming.

Bandwidth part (BWP) may indicate a contiguous set of physical RBs (PRBs) selected from a contiguous subset of the common RBs for a given numerology (u) on a given carrier. In the DL, a WTRU can be configured with up to four BWPs, with one carrier or DL BWP being active at a given time from the WTRU's perspective. The WTRU may not be expected to receive a physical downlink shared channel (PDSCH), a physical downlink control channel (PDCCH), a channel state information RS (CSI-RS), a tracking reference signal (TRS), or the like outside of an active BWP.

In the UL, a WTRU may be configured with up to four carrier BWPs, with one carrier BWP active at a given time or instance. If a WTRU is configured with a supplementary UL, the WTRU may be configured with up to an additional four carriers in the supplementary UL. In a configuration, one carrier BWP may be active at a given time, such as an active UL BWP, from the WTRU's perspective. The WTRU may not transmit a physical uplink shared channel (PUSCH) or physical uplink control channel (PUCCH) outside of an active BWP.

For each BWP, the following parameters may be configured control resource sets (CORESETs) for types of search spaces for DL BWPs in a primary cell (Pcell): a BWP indicator field in DCI format 1_1 may be used to indicate active DL BWP and a BWP indicator field in DCI format 0_1 may be used to indicate active UL BWP. For a Pcell, a WTRU may be provided by a higher layer parameter, Default-DL-BWP, a Default-DL-BWP among configured DL BWPs. If a WTRU is not provided a Default-DL-BWP parameter via a higher layer, the default BWP may be the initial active DL BWP. In certain configurations, a SRS may be transmitted within a BWP even when frequency hopping is activated.

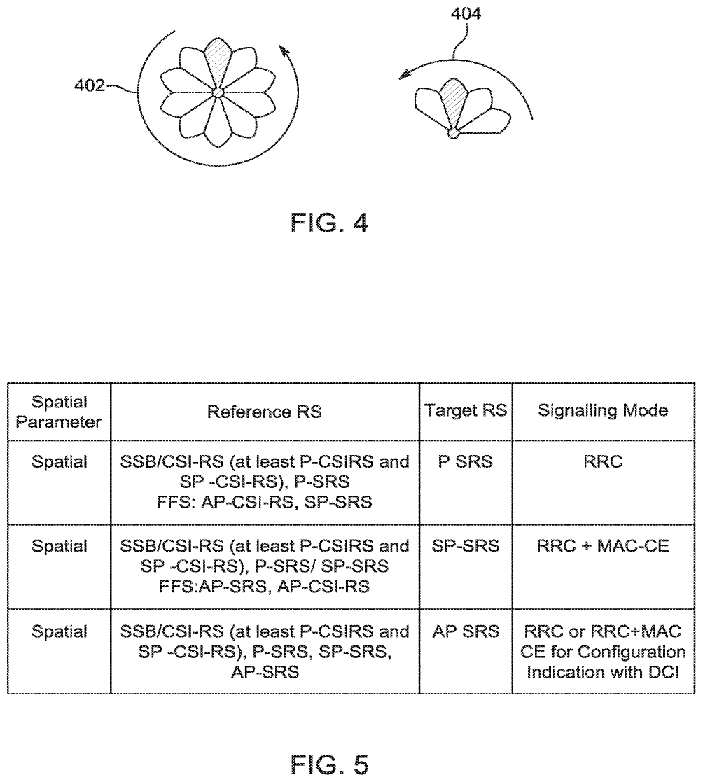

FIG. 4 illustrates an example of full or global sweeping 402 and partial or local sweeping 404 for a U-3 procedure. Full or global beam sweeping may be used to identify the optimal UL TX beam(s) from all or most WTRU TX beams, and may be used when there is no beam correspondence at the WTRU. When a partial beam correspondence is known, such that a WTRU knows the optimal subset of TX beams based on the RX beam determined, partial or local beam sweeping may be used to identify the optimal UL TX beam(s) within the optimal subset of beams.

SRS TX beam indication may be communicated by a SRS resource or by a DL RS. The DL RS may be a CSI-RS, synchronization signal blocks (SSB), or the like. FIG. 5 is a table with examples of spatial relations between a DL RS(s) and an UL SRS(s) TX beam. In certain configurations, an indicate or indication to a WTRU may be a command for the WTRU to perform some task, operation, procedure, or the like. In certain configurations, a received command may also be an indication.

The configuration of the spatial relation between a reference RS, which can be an SSB, a SS/Physical Broadcast Channel (PBCH) block, CSI-RS, SRS, or the like, and the target SRS may be indicated by a higher layer parameter. For instance, SRS-SpatialRelationInfo may be utilized. For details of SRS beam indication for UL BM, a similar or different message may be needed. Performing beam sweeping for U-1, U-2, U-3, or the like based on configured SRS-SpatialRelationInfo may also be desirable. A WTRU may determine a SRS beam indication for global or local TX beam sweeping, be configured for efficient SRS beam indication for UL BM with low latency, or the like.

Beam indication for multiple BWPs may also be desirable. For robustness against beam pair link (BPL) blocking in high frequencies, a WTRU may be configured with one or more DL beam(s) for PDCCH or PDSCH reception. Each DL beam may be represented or associated with a DL RS(s), such as a SSB, SS/PBCH block, CSI-RS, SRS, or the like. An associated DL RS(s) may be configured and transmitted per BWP or per composite carrier or component carrier (CC).

A WTRU may be configured with one or multiple BWPs for DL or UL. At a given time for each WTRU, only one BWP may be active for DL and UL, respectively. The active BWP may change dynamically based on available frequency/time domain (F/T) resources, additional bandwidth needed, radio environment degradation, interference, path loss, or the like. Before switching or changing to a new active BWP, the WTRU may consider candidate BWPs based on QoS and then select the target BWP. The WTRU may be configured, indicated, or triggered through a higher layer, RRC, layer 2, MAC Control Element (MAC-CE), L1 control, DCI, or the like to explicitly or implicitly measure a BWP(s) outside the active BWP. Similarly, the WTRU may also perform per-BWP based beam measurement, dynamic reporting, and associated beam indication. In case that WTRU is configured with one or more beams for multiple BWPs, efficient beam indication mechanism is desired to support different cases with low signaling overhead.

A beam indication for multi-TRP may be configured. In certain configurations, a maximum supported number of NR-PDCCHs corresponding to scheduled NR-PDSCHs that a WTRU can be expected to receive may be two per CC for one BWP for the CC. Multi-panels at WTRU may not be quasi-co-located (QCL'ed) because the panel orientations are different. For instance, two panels may face opposite sides. Low latency and efficient beam indication may also include SRS beam indication for UL BM, beam indication for multiple BWPs, and beam indication for multi-TRP/multi-panel. The beam indication for multiple BWPs may further include a beam indication for multiple DL BWPs, a beam indication for multiple UL BWPs, and a beam indication for UL and DL BWPs.

Activating a BWP for a DL and a BWP for an UL from a plurality of BWPs based on configuration information may also be performed. Evaluating at least one candidate BWP for the DL and at least one candidate BWP for the UL among the plurality of BWPs based on the configuration information may also be performed to achieve target performance. Dynamically changing the BWP for the DL and the BWP for the UL based on the at least one evaluated candidate BWP for the DL and the at least one evaluated candidate BWP for the UL may also be implemented in certain configurations.

The index of a specific beam may be configured by a high layer parameter such as SRS-SpatialRelationInfo. UL beam for SRS resource transmission may also be specified by associating the target SRS resource or the SRS resource to be transmitted with a reference RS resource indicated by SRS-SpatialRelationInfo. In certain configurations, SRS-SpatialRelationInfo may be set to a CSI-RS resource or SS/PBCH resource if full or partial beam correspondence holds. SRS-SpatialRelationInfo may be also set to a SRS resource if full, partial, or no beam correspondence holds. Based on the configured high layer parameter SRS-SpatialRelationInfo, the WTRU may determine the spatial domain transmission filter or beam(s) to transmit the SRS resource.

Each SRS resource may configured by a high layer parameter, such as SRS-SpatialRelationInfo, or to reduce configuration overhead, SRS resources within a SRS resource set may be divided into multiple groups or sub-sets and for each group or sub-set of SRS resources there may a single group or sub-set level high layer parameter SRS-SpatialRelationInfo. Configurations may include N groups or sub-sets of SRS resources within a SRS resource set. The value of N may be equal to or greater than 1. When N is equal to 1, the SRS resources within a SRS resource set may be configured with one single high layer parameter and be considered as a set level parameter.

If none of the SRS resources within a set is configured with a high layer parameter or predefined to indicate an index of a specific beam(s), the WTRU may transmit using these SRS resources with different spatial domain transmission filters or UL TX beam directions. This operation may be based on WTRU beamforming capabilities, a number of configured UL TX beamforming directions, dynamic network indications, L1 messages, DCI messages, higher layer configurations, RRC configurations, layer 2 control elements, MAC-CE, full or partial beam correspondence, transmit SRS resources with the spatial domain transmission filters corresponding to the DL RX beam directions based on WTRU DL beam measurement results, or the like. In certain configurations, different spatial domain filters may cover all WTRU UL TX beamforming directions or global UL TX beam sweeping for an UL BM procedure, such as U-1. Different spatial domain filters may also cover part of UL TX beamforming directions or partial or local UL TX beam sweeping for UL BM procedure, such as U-3.

When none of the SRS resources within a set is configured with the high layer parameter, the WTRU may also still perform fixed TX beam(s) transmission, such as U-2, or local UL TX beam sweeping, such as U-3. With dynamic gNB indications to trigger the SRS beam sweeping, information element SRS-ResourceRep may include and configured in a higher layer, RRC, layer 2, MAC-CE message or trigger, or a DCI element or DCI entry or DCI field SRS-ResourceRep. Information element SRS-ResourceRep may be utilized for triggering by L1 signaling DCI, an aperiodic SRS trigger, SRS request, or the like. This information associated with a SRS resource set may indicate whether a repetition related to a spatial domain transmission filter is ON/OFF at WTRU-side. In this configuration, a WTRU may transmit utilizing different SRS resources within a SRS resource set by using the same beam or different beam(s)). If repetition is ON, a single beam index may be explicitly included or implicitly indicated and may use or refer to the optimal or best RX beam(s) that the WTRU measured or used in the recent DL beam measurement procedures in this triggering message so that the WTRU transmits utilizing the SRS resources with the same spatial domain transmission filter indicated by the single beam index. If the repetition is OFF, a set of beams may be indicated to the WTRU to perform UL TX beam sweeping.

A WTRU may autonomously determine the set of beams based on beam correspondence and DL beam measurement. For example, a single beam index may be indicated in a triggering message, and the WTRU may apply a range of DL RX beams corresponding to the related DL TX beams that are identified during the last or prior DL beam measurements. The range of the beams may be decided based on measured layer 1-reference signal received power (L1-RSRP) value, a N dB offset, or the beams geographically close to the indicated single beam. For instance, if the indicated single beam is X and the indicated beam range is five, the WTRU may sweep five beams that are centered at the beam X, such as two beams on the left side of beam X and two beams on the right side of beam X.

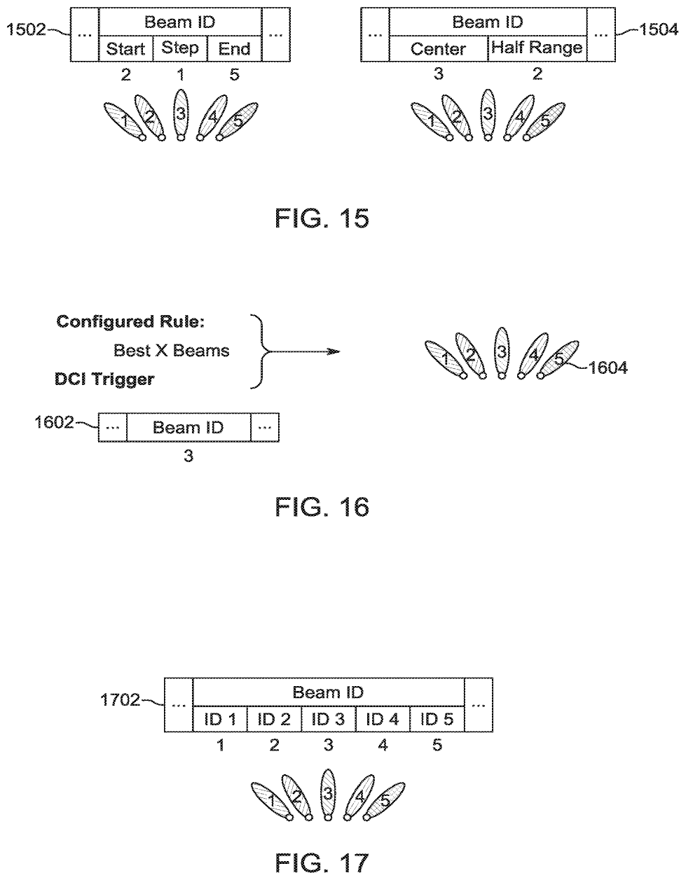

FIG. 15 illustrates an example of a WTRU U-3 sweeping range. FIG. 16 illustrates another example of a WTRU U-3 sweeping range. In FIG. 15, the field of beam indication or identification (ID) or Beam indication or identification (ID) may include a start ID, a start beam ID, an end ID, or an end beam ID with a step size in 1502. In another configuration, a center beam and half range in 1504 may be utilized to determine beam sweeping. In FIG. 16, the beam range may be based on both higher layer configuration and lower layer triggering message(s). A beam ID may be utilized to reduce over the air signaling for beam determination. A rule may be specified or configured in a WTRU, such consider optimal X beams, where X is a configurable value. When the WTRU receives a DCI triggering message that comprises a beam ID with value 3 in 1602, the WTRU may derive or determine the optimal or best X=4 beams around the indicated beam 3 in 1604 as the beam range to sweep in an U-3 procedure. This may be performed based on the last or prior DL measurement.

The WTRU may transmit utilizing the SRS resources with spatial domain transmission filters indicated by each configured SRS-SpatialRelationInfo for each SRS resource. The WTRU may also perform UL TX beam sweeping by transmitting on all SRS resources with the beams indicated by the high layer parameter SRS-SpatialRelationInfo configured to each SRS resource or groups, with the group number N>=1, of SRS resources, within the set.

If the high layer parameter(s) SRS-SpatialRelationInfo, where a group of SRS resources share the same parameter or each resource has its own parameter, configured for all the SRS resources is set to the same content, the WTRU may transmit utilizing all the SRS resources with the same spatial domain transmission filter or beam(s). In this configuration for U-2, the network device, gNB, or TRP may perform UL RX beam sweeping while the WTRU transmits SRS resources with the same TX beam(s).

In another embodiment, if the high layer parameter(s), such as SRS-SpatialRelationInfo, for all the SRS resources is set to the same content or same RS resource ID, or a single set level high layer parameter SRS-SpatialRelationInfo is configured for all the SRS resources, the WTRU may perform local or partial UL TX beamforming and transmit using these SRS resources with different beams. This configuration may apply to U-3 procedures and different beams may be spatially close to the beamforming direction indicated by the high layer parameter SRS-SpatialRelationInfo.

Additional or extra information may be needed for the WTRU to decide whether to transmit SRS resources with similar or different spatial domain transmission filter(s) or beam(s) when SRS resources within a resource set is configured with multiple high layer parameters, such SRS-SpatialRelationInfo, but per-resource parameters have the same content or same reference RS ID or a single set level high layer parameter SRS-SpatialRelationInfo. Additional or extra information in the higher layer, RRC, or the like configuration may indicate whether the WTRU performs UL TX beam sweeping or uses fixed UL TX beam.

A high layer parameter SRS-ResourceRep may indicate UL beam sweeping type or UL BM procedure, such as U-1, U-2, or U-3. Parameter SRS-ResourceRep may be specified and configured by RRC, and this parameter associated with a SRS resource set may define whether a repetition in conjunction with spatial domain transmission filter is ON or OFF at the WTRU. A WTRU may transmit utilizing different SRS resources within a SRS resource set by using a same beam or different beam(s). For example, if SRS-ResourceRep=ON, it may indicate to the WTRU to perform a U-2 procedure or a network device, gNB, TRP, or the like to perform UL RX beam sweeping. If SRS-ResourceRep=OFF, it may indicate to the WTRU to perform a U-1 procedure, a U-3 procedure, WTRU UL TX beam sweeping, or the like.

Additionally, this indication information may be communicated with dynamic signaling, a higher layer message, a RRC message, a layer 2 message, a MAC-CE, a L1 control message, a DCI, or the like. Dynamic signaling may be transmitted from a network device, gNB, TRP, or the like to a WTRU to activate one or a subset of the configured SRS set(s) for a WTRU to perform UL BM. For example, an aperiodic SRS resource set may be activated or triggered by DCI where flag information indicates if the WTRU transmits this SRS resource set with UL TX beam sweeping or a fixed UL TX beam(s). In certain configurations, dynamic signaling may also be dedicated to indicate when or if the WTRU performs UL TX beam sweeping.

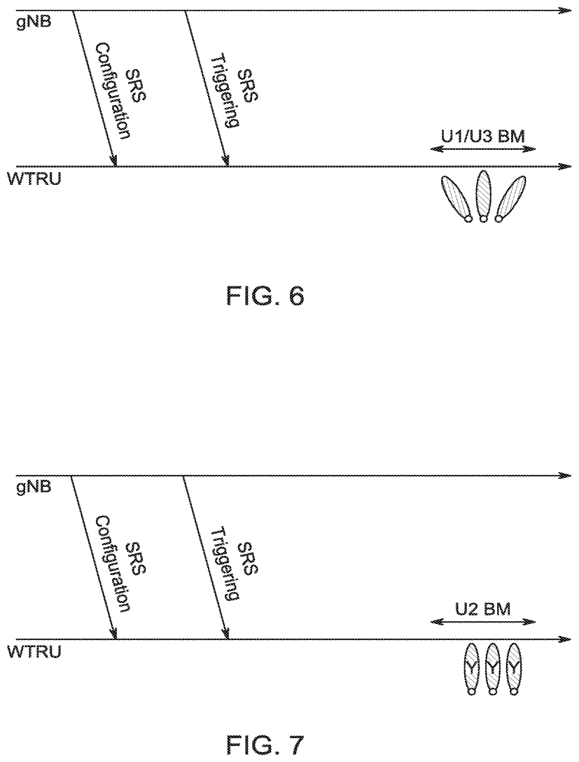

FIG. 6 illustrates an example of signaling for BM. In FIG. 6, a SRS configuration message and a SRS triggering message, such as a RRC or DCI trigger, may be received by the WTRU. No beam indication information may be included in the SRS triggering message. In this configuration, the WTRU may follow the SRS configuration, SRS-Resource-Rep, SRS-SpatialRelationInfo, or the like. Without beam indication information in the SRS triggering message, the WTRU may utilize the SRS resources with the spatial domain transmission filter(s) specified by the SRS configuration information that may indicate which WTRU performs the UL TX beam sweeping, such as SRS-ResourceRep set to OFF, with the transmission filters specified by high layer parameters, such as SRS-SpatialRelationInfo.

If a subset of all SRS resources of a SRS set are configured with the high layer parameter SRS-SpatialRelationInfo and other SRS resources are not configured, the WTRU may transmit only on those SRS resources configured, with the spatial domain transmission filter(s) indicated by SRS-SpatialRelationInfo. Transmissions on SRS resources may utilize the same transmission filter or different transmission filters. On the other SRS resources, which are not configured with SRS-SpatialRelationInfo, the WTRU may not transmit.

If a SRS resource in a SRS resource set is configured with the high layer parameter SRS-SpatialRelationInfo, or multiple SRS resources in a SRS resource set share a group level or set level by high layer parameter SRS-SpatialRelationInfo, the WTRU may determine that the reference in the activation command, to activate a SRS resource set to be used for UL BM, to the RS resource overrides SRS-SpatialRelationInfo. For example, a SRS resource within a SRS resource set may be configured to be transmitted over beam X. When the SRS resource set is activated, the activation command may indicate beam Y for the SRS resource set. The WTRU may then transmit using all SRS resources over beam Y, instead of beam X. An activation command may be included in higher layer, RRC, layer 2, MAC-CE, layer 1, or DCI signal.

For activation or triggering of aperiodic SRS, DCI may include a resource set activation, resource repetition flag, UL beam indication, or the like. With respect to the resource set activation, multiple aperiodic (AP)-SRS resource sets may be RRC or RRC+MAC-CE configured, but triggered or activated by L1 control or DCI. A DCI filed, such as SRS request field, may be used to indicate which SRS set(s) is triggered. When only one SRS set is configured, this DCI field may or may not be needed.

The resource repetition flag may be a 1-bit DCI field to indicate whether the SRS resources within activated SRS resource sets are transmitted with the same UL spatial domain transmission filter. SRS resources in the resource set may be transmitted in different OFDM symbols. A resource repetition flag may comprise similar information as high layer parameter SRS-ResourceRep and may or may not be present in L1 control or DCI. If a resource repetition flag is not present in the DCI where a SRS resource set is triggered, the WTRU may transmit a SRS resource set according to the high layer parameter SRS-ResourceRep. This may be considered as hybrid SRS beam indication that combines DCI indication and higher layer or RRC configuration(s). As an example, DCI may indicate the resource set activation or the beam direction(s) for UL Rx beam sweeping with a fixed beam transmission, such as U-2, or UL Tx beam sweeping with different beam transmission, such as U-3, and the RRC configurations may specify the transmission type or resource repetition type of the SRS resources in this resource set, such as U-2 or U-3.

FIG. 7 illustrates another example of signaling for BM. FIG. 7 shows triggering and configuration combined SRS beam indication for BM where the WTRU uses higher layer or RRC configurations to determine SRS resource repetition type and a SRS triggering message to determine the spatial domain transmission filter(s). A SRS configuration message and a SRS triggering message may be received by the WTRU. The SRS triggering message may comprise a single beam index Y, and the WTRU follows the SRS configuration to determine repetition type, such as a set to ON, and then may utilize a fixed UL TX beam Y.

For certain configurations, if a resource repetition flag is present in a DCI, regardless of high layer parameter SRS-ResourceRep information, the WTRU may transmit this SRS resource set according to the DCI flag. In this configuration, the flag may override the high layer parameter SRS-ResourceRep. In this configuration, SRS beam indication may be in L1 signaling only or communicated by L1 signaling only, such as if the UL beam indication is in DCI. In addition, when a triggering message such as DCI comprises SRS beam indication information, it may override the beam indication information configured in high layer SRS configurations.

UL beam indication information may or may not be present in DCI. This beam indication information may be communicated in one or more SRS resource indicator (SRI) fields in DCI. In certain configurations, the SRI field may be the same or different field as the SRI field used for PUSCH transmission.

If beam indication information is not present in DCI, the WTRU may utilize the SRS resources within the triggered or activated SRS resource set with the spatial domain transmission filter indicated by the high layer parameter SRS-SpatialRelationInfo. In this case, SRS beam indication scheme may be a hybrid solution which may combine DCI indication and higher layer or RRC configuration(s). If N>1 SRS resources are configured with different SRS-SpatialRelationInfo, the WTRU may perform UL TX beam sweeping, such as in U-1 or U-3. If N>1 SRS resources are configured with the same value of SRS-SpatialRelationInfo, the WTRU may perform fixed beam transmission, such as U-2.

If no SRS-SpatialRelationInfo is configured, or the configured SRS-SpatialRelationInfo is without a valid or proper RS resource ID, the WTRU may determine that a network device, gNB, TRP, or the like does not specify information of the UL TX beam. In certain configurations, the WTRU may then perform global beam sweeping for a BM procedure, such as U-1. For example, the WTRU may perform initial UL beam training when the WTRU is configured with a higher layer or RRC connection from initial access.

If no SRS-SpatialRelationInfo is configured, the WTRU may perform a U-2 procedure or a U-3 procedure. For example, if the repetition is ON, a single beam index may be explicitly included or implicitly indicated, such as if the WTRU utilizes the optimal RX beam that the WTRU measured or used in a recent DL beam measurement procedure, in a triggering message. In this configuration, a WTRU may transmit using the SRS resources with the same spatial domain transmission filter indicated by the single beam index.

If repetition is OFF, a set of beams may need to be indicated to each WTRU from the network to perform UL TX beam sweeping. A WTRU may also autonomously determine the set of beams based on beam correspondence and DL beam(s) measurement. For example, a single beam index may be indicated in the triggering message and the WTRU may apply a range of DL RX beams corresponding to the related DL TX beams that are identified during the last or prior DL beam measurements. The range of the beams may be based on a measured L1-RSRP value (e.g., N dB offset) or beams that are geographically close to the indicated single beam. For instance, if the indicated single beam is X and the indicated beam range is 5, the WTRU may sweep five beams that are centered at the beam X, such as two beams on the left side of beam X and two beams on the right side of beam X.

If beam indication information is present in a DCI or L1 signal, the WTRU may transmit using the SRS resources. If beam indication information is present in DCI and the beam indication information specifies one beam, the WTRU may perform UL TX beam sweeping or fixed beam transmission by checking if a resource repetition flag exists in current DCI. If the resource repetition flag indicates UL TX beam sweeping, the WTRU may determine the single beam indication comprises coarse information for a UL TX beam which may be refined. In this configuration, the WTRU may perform local or partial beam sweeping around or centered at this single beam. The number and directions of the swept local beams may be determined by the WTRU based on previous DL beam measurement and reporting. If the resource repetition indicates fixed beam transmission, the WTRU may utilize SRS resources with the beam indicated by the beam indication information in DCI. If the DCI does not include the resource repetition flag, the WTRU may check whether the high layer parameter SRS-ResourceRep is configured for the activated SRS resource set.

If beam indication information is present in DCI and the beam indication information specifies no beam, the WTRU may check for a resource repetition flag in DCI. If resource repetition flag is present, the WTRU may perform TX beam sweeping if the resource repetition flag is set to OFF and the swept beams are indicated by the high layer parameter SRS-SpatialRelationInfo. If the resource repetition flag is set to ON, the WTRU may utilize the SRS resources with a fixed beam, which is also indicated by the high layer parameter SRS-SpatialRelationInfo received in the SRS configuration message.

If beam indication information is present in DCI and the beam indication information specifies multiple beams, the WTRU may select one beam for fixed beam transmission of a SRS resource set, if indicated by the resource repetition flag or high layer parameter SRS-ResourceRep. Otherwise, the WTRU performs TX beam sweeping with the beams indicated by the beam indication information in DCI.

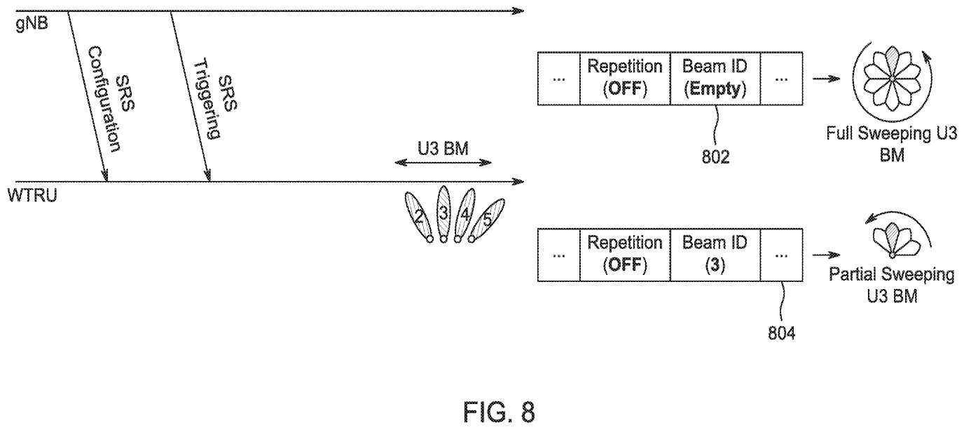

FIG. 8 illustrates another example of signaling for BM. A WTRU may utilize a SRS triggering message to determine the SRS resource repetition types and the spatial domain transmission filter(s) when the WTRU does not use SRS configuration. In FIG. 8, a SRS configuration message and a SRS triggering message may be received by the WTRU. The SRS triggering message may comprise a SRS repetition type field and beam ID field. In certain configurations, the beam ID field may override the configured SRS-SpatialRelationInfo received in the SRS configuration message.

In examples 802 and 804, the SRS repetition type field may indicate OFF. In example 802, the beam ID may comprise empty information which indicates that a network device, gNB, TRP, or the like has no coarse direction indicated and the WTRU may perform a full sweeping U-3 procedure. In example 804, the beam ID may indicate a specific beam, for instance beam 3, for the WTRU to perform partial beam sweeping around the coarse beam direction centered at beam 3. The WTRU may sweep a TX beam(s) according to previous UL beam(s) measurements, previous UL TX beam sweeping, previous DL beam measurements, beam correspondence, and derive or generate multiple TX beams around the indicated beam 3. In this example, WTRU may sweep beams 2, 3, 4, and 5 since during a last or prior DL beam measurement the WTRU maintained several DL RX beams, part of which correspond to these four beams.

In example 804, the field of beam ID may comprise more than one RS ID. FIG. 17 illustrates an example of an implicit procedure for WTRU U-3 sweeping range determination. In 1702, the beam ID field may include a list of beams for implicitly determining a U-3 sweeping range. In certain configurations, a hybrid method may be configured to combine FIG. 17 with other sweeping range determination given herein. For example, the beam field may comprise a start beam ID and an end beam ID, while the beams selected between the start and end beam ID are determined by a higher layer rule, such as X beams with the highest L1-RSRP instead of a step field.

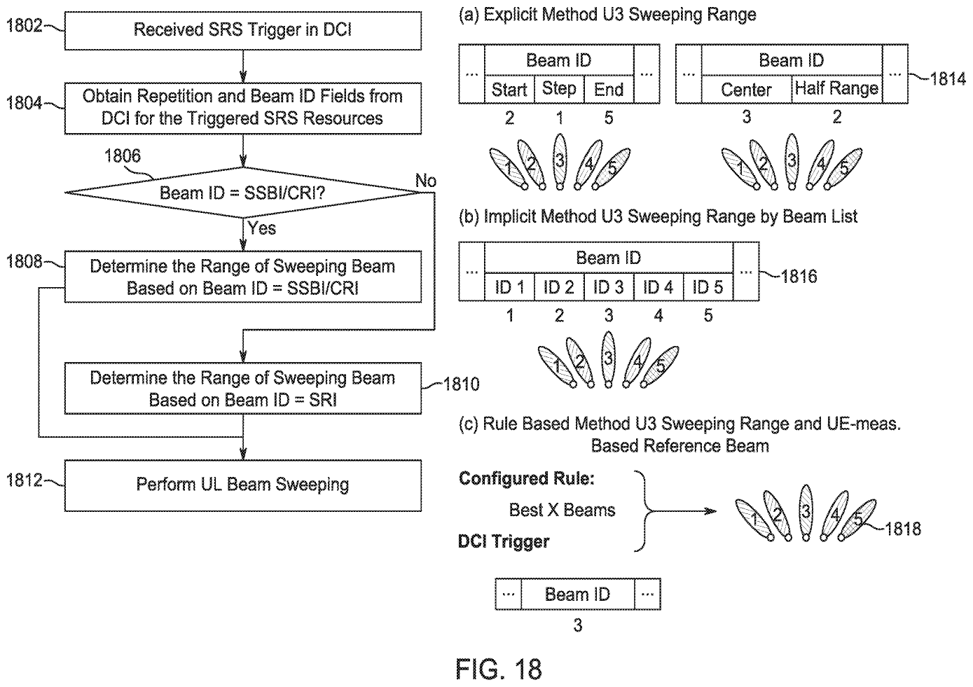

FIG. 18 illustrates an example of a procedure for a WTRU to determine beam sweeping for triggered SRS resources for UL BM. A WTRU may receive a SRS trigger in DCI (1802). A repetition field or beam ID field may be obtained for the triggered SRS resources (1804) from the received DCI. The repetition field may indicate whether WTRU performs U-2 or U-3 procedure. The beam ID field may comprise one or more DL RS ID, such as SSBI or CRI (1806), or UL RS ID, such as SRI.

If beam ID field comprises a DL RS ID, the beam range may be derived based on the last or prior DL beam measurement results (1808) and UL beam sweeping performed (1812). If beam ID field comprises an UL RS ID, the beam range may be derived based on the last or prior UL beam measurement results (1810) and UL beam sweeping performed (1812). The beam sweeping range may be derived by an explicit operation 1814 using various parameters, an implicit operation 1816 using various parameters, or a rule based operation 1818. In the explicit operation, the WTRU may determine a range based on the geographical location to the indicated beam. In an implicit operation, the WTRU may determine a range by a beam list. In a rule-based approach, the WTRU may autonomously determine the beam sweeping range from the last or prior DL or UL beam measurement results. Additionally, a hybrid procedure may utilize a higher layer or RRC configuration where the two fields that may be partly or all present in the DCI may be partly or all configured in the RRC message. One or both fields may be part of DCI fields or configured as RRC parameters. In configurations where the same field(s) is present in both RRC configuration and DCI, SRS beam indication field in DCI may override the same field configured in RRC.

Beam indication for multiple BWPs may be configured. For robustness against beam pair link blocking in high frequencies, a WTRU may be configured with one or more DL beams for PDCCH or PDSCH reception. Each DL beam may be represented or associated with a DL RS(s), such as SSB, SS/PBCH block, CSI-RS, SRS, or the like. An associated DL RS(s) may be configured and transmitted per BWP or per CC.

A WTRU may be configured with one or multiple BWPs for the DL or the UL where at a given time moment, for each WTRU, only one BWP may be active, for the DL and the UL, respectively. This single active BWP may change dynamically as available frequency or time resources change, a wider bandwidth is needed, radio environment degradation, interference, path loss, or the like. Before switching or changing to a new active BWP, the WTRU may evaluate candidate BWPs based on QoS and then select the target BWP properly. Therefore, the WTRU may be configured, indicated, or commanded via higher layer, RRC, layer 2, MAC-CE, L1 control, DCI, or the like to explicitly or implicitly measure some BWPs outside the active BWP. In other words, WTRU may be configured or triggered via RRC, MAC-CE, DCI, or the like to perform per-BWP based beam measurement and reporting dynamically.

Since a WTRU may be configured with multiple beams across multiple BWPs, efficient per-BWP based beam indication may be configured. Different configurations may include beam indication for multiple DL BWPs, beam indication for multiple UL BWPs, and beam indication for UL and DL BWPs. For beam indication for multiple DL BWPs, a DCI, a transmission configuration indication (TCI), a DCI table, or a TCI table may be utilized. A hybrid procedure with a combined DCI/TCI and TCI table may also be configured.

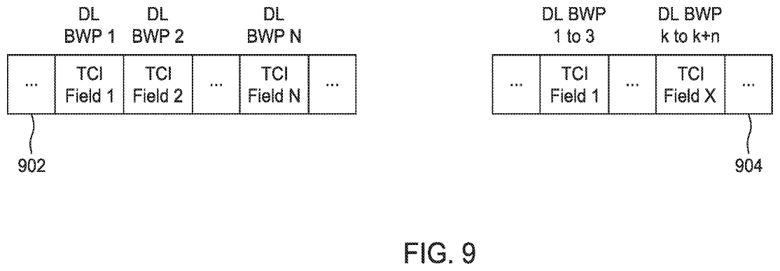

FIG. 9 illustrates an example of DCI or TCI for beam indication for multiple DL BWPs. In FIG. 9, multiple TCI fields may be part of DCI for the beam indication of multiple DL BWPs. In 902, each TCI field may represent the indicated TCI state for one BWP for independent beam indication. For example, in 902 TCI field 1 only comprises the TCI state for DL BWP 1. In 904, one TCI field may comprise a value of indicated TCI state for more than one DL BWP for joint beam indication. For example, TCI field 1 in 904 may comprise a value of indicated TCI state for 3 DL BWPs including DL BWP 1, DL BWP 2 and DL BWP 3.

One or any combination of two configurations to indicate the TCI state for each TCI field in independent beam indication or joint beam indication for multiple DL BWPs may be configured. In a first configuration, a normal beam indication may be represented by an absolute value of TCI state for each TCI field. In a second configuration, differential beam indication may be represented by an absolute value of TCI state for the reference TCI field and use the differential value for the rest of TCI fields relative to the reference TCI field. For example, in FIG. 9, each TCI field may comprise an absolute value of a TCI state, such as 902 or 904 when normal beam indication is used or configured by RRC. For another example in FIG. 9, when differential beam indication is used or configured by RRC, the reference TCI field may select the TCI field with the TCI state with the highest or lowest index among all TCI fields in the same DCI. For instance, in 904, TCI field K may indicate TCI state S and S may be the highest index among the TCI states signaled by all TCI fields in the same DCI. In another configuration, the reference TCI field may select the TCI field with lowest or highest field index, such TCI field 1 or N in 902.

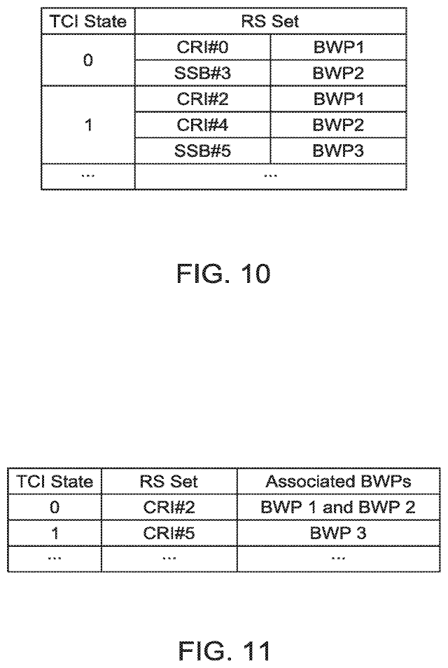

FIG. 10 is a table with examples of TCI table based beam indication for multiple DL BWPs. In FIG. 10, a TCI state may comprise a RS set with multiple RS IDs for multiple BWPs. For example, TCI state 0 indicates CRI #0 and SSB #3 for BWP1 and BWP2, respectively. In this configuration, cross-carrier or cross-BWP beam indication may utilize a TCI state or table. When a WTRU receives one TCI field in a DCI, which beam is indicated to the WTRU for subsequent PDSCH reception may be based on the current active BWP of the WTRU. For example, if the WTRU receives a TCI field with value 1, the WTRU may apply beam CRI #4 if the WTRU's current active BWP is BWP2. When the WTRU switches active BWPs dynamically by DCI-based or timer-based switching, the corresponding beam used for PDSCH reception for the target BWP may change correspondingly. For example, if the target BWP is BWP1 or BWP3, the WTRU may use beam CRI #2 or SSB #5 for PDSCH reception respectively.

For implicit DL beam indication with a TCI table, each TCI state may explicitly indicate the RS ID in one RS set for a BWP. A TCI state may implicitly indicate a beam(s) for PDSCH or PDCCH reception for multiple BWPs. A default TCI state may also be predefined for PDSCH or PDCCH reception upon BWP switching. For example, a TCI state with a specific ID or lowest ID of the currently configured TCI state may be used by a WTRU until the reconfiguration or re-activation for PDCCH reception, reconfiguration, re-activation, or DCI triggering for PDSCH reception. A default TCI state may be BWP specific or CC-specific.

The TCI state currently used for a specific BWP, such as an old BWP before BWP switching or a default/initial BWP configured to a WTRU, when the WTRU switches to a target or new BWP, may be used by a WTRU until the reconfiguration or re-activation for PDCCH reception or reconfiguration, re-activation, or DCI triggering for PDSCH reception. For the PDSCH reception on a new BWP, a WTRU may use the TCI state activated for the PDCCH reception on the same BWP or a specific BWP. For instance, the original BWP used by a WTRU before BWP switching or a default or initial BWP configured to a WTRU may be utilized.

A WTRU may be configured to receive the assignment DCI for PDSCH beam indication and receive X TCI fields (X>=1) in the DCI. If the TCI table maintained by the WTRU comprises some TCI states that are associated with multiple BWPs, the X TCI fields may indicate beam(s) for PDSCH reception for Y BWPs, where the value Y>=X.

FIG. 11 is a table with examples of a hybrid solution for beam indication for multiple DL BWPs. In FIG. 11, if a WTRU receives two TCI fields which indicate TCI state 0 and 1, the WTRU may be configured to identify the proper beam(s) used for subsequent PDSCH reception if the WTRU uses any one of BWP 1, BWP 2, or BWP 3.

In configurations where a WTRU receives a TCI field indicating a TCI state that does not comprise a beam(s) for the current active BWP, the WTRU may switch to a BWP based on predefined rules. For example, the WTRU may switch to a common BWP that is available to all WTRUs within a network device, gNB, TRP, or the like area, or to a specific BWP that has lowest ID in a TCI table.

For PDSCH reception, if the time offset between the reception of the DL DCI and the corresponding PDSCH is less than a threshold, such as Threshold-Sched-Offset, the WTRU may determine that the antenna ports of one DM-RS port group of PDSCH of a serving cell are QCLed based on a default TCI state used for a PDCCH QCL indication of the lowest CORESET-ID in the latest slot in which one or more CORESETs are configured for the WTRU. A WTRU may be configured with one or multiple CORESETs and also may be configured with one or multiple BWPs. A default TCI state corresponding to the PDCCH TCI state with the lowest CORESET-ID may be BWP specific, CC specific, or the like. For certain configurations, if the time offset is less than the Threshold-Sched-Offset, the WTRU may determine the beam indicated by the default TCI state in the active BWP. A default TCI state may be reused across multiple BWPs if the default TCI state corresponding to the PDCCH with the lowest CORESET-ID is configured for multiple BWPs, such as TCI state 0 in FIG. 11.

For the lowest CORESET-ID, note that CORESET 0 of all the CORESET(s) configured to a WTRU may be configured during WTRU initial access. For example, CORESET 0 may be configured by a PBCH. After the WTRU enters RRC connected mode, the WTRU may configure or update the TCI state for CORESET 0. When the WTRU determines the lowest ID of CORESET for PDSCH reception in the case that the time offset is less than the Threshold-Sched-Offset, the WTRU may utilize the TCI state corresponding to CORESET 0.

If a SS/PBCH block identified during initial access is the beam(s) used for the WTRU for PDSCH reception and the TCI state for CORESET 0 is configured, then the TCI state for CORESET 0 may be considered as the default TCI state. If the TCI state corresponding to CORESET 0 is updated for the beams in a RRC connected state or mode, such as during initial access, then the TCI state for CORESET 0 may also be utilized. When a WTRU is in a beam failure recovery procedure, a dedicated CORESET-BFR may be configured for monitoring network response for a beam failure recovery request. In this case, when the WTRU determines default beam/QCL reference for PDSCH reception in the case that the time offset is less than the Threshold-Sched-Offset, the CORESET-BFR should not be considered as the CORESET with lowest ID unless the WTRU is in the beam failure recovery mode. This lowest CORESET-ID may be identified by considering the latest slot. When a WTRU is configured with multiple CORESET(s)/search space(s), the CORESET(s)/search spaces(s) may be configured to have slot information so that the latest slot may be determined.

If PDSCH and PDCCH reception for a WTRU is across multiple BWPs or CCs, the spatial QCL reference may be utilized. As an example for this configuration, a PDCCH may be scheduled or transmitted in BWP1/CC1, such as below 6 GHz for higher reliability, and a PDSCH may be scheduled or transmitted in BWP2/CC2, such as above 6 GHz for higher capacity.

In FIG. 10, TCI state 0 may comprise two RS IDs for two different BWPs. For PDCCH and PDSCH reception, the same TCI state 0 may be activated (for PDCCH)/indicated (for PDSCH), but different beams, such as corresponding to different RS IDs, may be indicated to the PDCCH and PDSCH, respectively. Regardless of the scheduling offset between DL DCI and PDSCH being less than or larger than the Threshold-Sched-Offset, the default TCI state corresponding to PDCCH/CORESET with lowest ID may be the TCI state 0 in FIG. 10. A WTRU may also be configured with different TCI states for PDCCH and PDSCH reception, respectively, where one TCI state may be configured in one BWP/CC or in multiple BWPs/CCs. In this configuration, when the scheduling offset between DL DCI and PDSCH is less than the Threshold-Sched-Offset, the WTRU needs to find the default TCI state which may be different from the TCI state indicated in the DCI field.

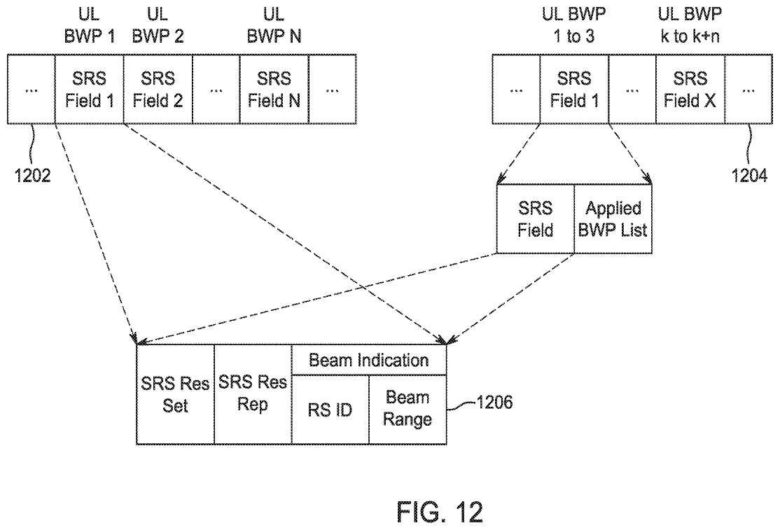

SRS beam indication for UL BM may be utilized for a single BWP. FIG. 12 illustrates an example of utilizing DCI or TCI for SRS beam indication for BM across multiple UL BWPs. For independent beam indication in 1202, each SRS field may comprise beam indication information for one UL BWP. For joint beam indication in 1204, one SRS field may comprise beam indication applied to multiple UL BWPs.

As shown in FIG. 12, a SRS field may comprise a plurality of parameters or sub-fields. In 1206, the parameters or sub-fields may be a SRS Res set field, a SRS Res rep field, and a beam indication field which may include a central RS ID field and a beam range field. The SRS Res set field may be utilized for SRS resource set activation. For example, it may be the SRS request field.

The SRS Res rep field may be a flag field used to indicate whether the WTRU transmits the SRS resources within the activated SRS resource set with the same or different spatial domain transmitter filter(s), or with a fixed UL TX beam or UL TX beam sweeping. The field may be set to ON or OFF to indicate that the WTRU utilizes different SRS resources within a SRS resource set by using a same beam(s) or different beam(s). The beam indication field may be utilized to indicate beam information for transmissions of different SRS resources.

The central RS ID field may be a RS ID, DL RS ID, SS/PBCH block ID, CSI-RS resource ID, a SRS resource ID, or the like. If the SRS Res rep field indicates that the WTRU perform fixed beam transmission, such as procedure U-2, the RS ID may indicate the single fixed beam for U-2. If the SRS Res rep field indicates that the WTRU perform fixed beam transmission, such as procedure U-2, the RS ID may also indicate a coarse beam direction. If the field is empty, the WTRU may perform global UL TX beam sweeping within the associated BWP.

The beam range field may be used in case the RS ID in the central RS ID field indicates a coarse beam direction. For example, the WTRU may derive or generate multiple TX beams around an indicated coarse beam. The WTRU may sweep TX beams according to previous UL beam measurements, such as previous UL TX beam sweeping, or previous DL beam measurements, such as beam correspondence, and determine local UL TX beam sweeping. The beam range field may be used to confine the number of beams or the range of beams the WTRU may generate or derive based on previous UL or DL BM.

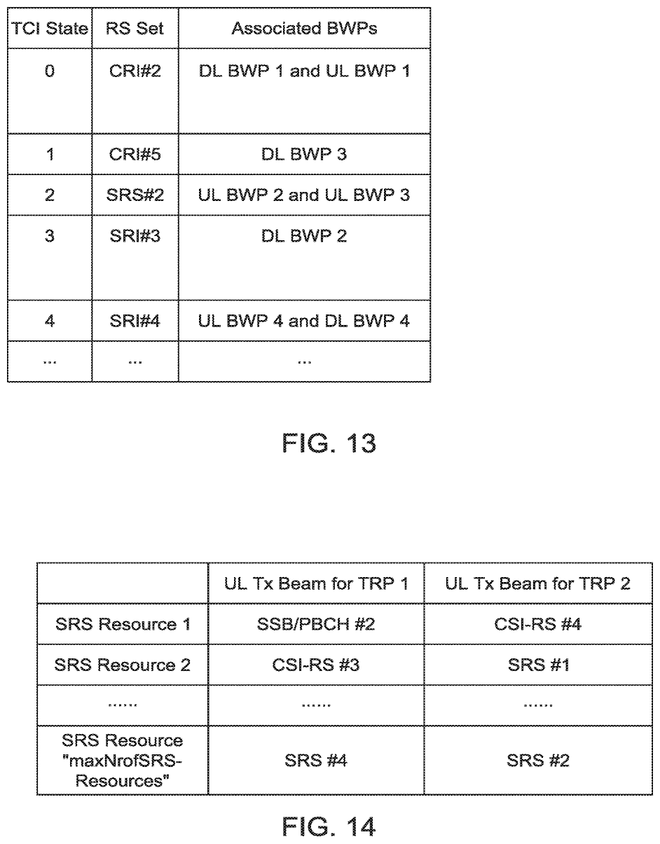

FIG. 13 is a table with examples of a TCI table based configuration for beam indication for multiple DL and UL BWPs. In FIG. 13, beam indication for both UL and DL BWPs may be performed jointly. A WTRU may be configured with a TCI table where some TCI states may comprise RS sets that are applicable to multiple UL and DL BWPs, such as the TCI state 0. In this configuration, it may indicate that the associated DL BWP and UL BWP are co-located such that two frequency bands are sufficiently close to each other or completely overlap.

For multiple DL BWPs, multiple UL BWPs, or both UL and DL BWPs, if a WTRU receives a beam indication that indicates a beam is not for a current active BWP, it may indicate that the network may initiate and trigger BWP switching. The target BWP for the WTRU may be mapped based on the indicated beam. For example, if a WTRU receives a TCI field indicating TCI state 1 as shown in FIG. 11, the WTRU may switch to BWP 3. If multiple potential target BWPs exist based on the indicated beam indication, the WTRU may switch to a default BWP. The default BWP may be the BWP with which the WTRU is configured with initially. The WTRU may also switch to a BWP based on predefined rules. For example, the WTRU may switch to a common BWP that is available to all WTRUs within a network device area or to a specific BWP that has the lowest ID in the TCI table.

In the example given herein, a WTRU may also be configured to have one or multiple UL or DL active BWP(s), which may indicate simultaneous transmissions over one or multiple UL or DL BWP(s). The examples given herein may apply to single carrier transmissions, multi-carrier transmissions, multi-BWP transmissions, or the like. In certain configurations, the maximum supported number of NR-PDCCHs corresponding to scheduled NR-PDSCHs that a WTRU can be expected to receive may be two per CC basis in case of one BWP for the CC.

For multi-TRP configurations, separate high layer signaling or DCIs may be communicated to the same WTRU. For the UL BM, the SRS beam indication may be in separate DCI or high layer signaling from each TRP. For example, the SRI field or SRS-ResourceRep field, which may be extended, in DCI may indicate the UL TX beam(s). Also, the SRS-SpatialRelationInfo and SRS-ResourceRep in high layer configurations may indicate the UL TX beam(s).

Also for multiple TRP configurations, joint beam indication for an UL TX beam(s) to multi-TRP may be used to save signaling overhead. A WTRU may simultaneously connect with two or more TRPs. One of the TRPs may send the WTRU SRS-Resource configurations for both TRPs. This TRP may be configured as the lead, primary, or serving TRP, and the other TRP(s) as the member or secondary TRP. Also, two or more TRPs may share the same association between SRS resources and beams or spatial domain transmission filter. The SRS-spatialRelationInfo may also indicate a common association.

It may be possible that two or more TRPs do not share the same association between SRS resources and beams or use different SRS resource and beam pairs. In this configuration, the lead TRP sends the SRS-SpatialRelationInfo, which comprises the association of SRS resources with different beams. FIG. 14 is a table with examples of association of the SRS resource with spatial domain transmission filters for multiple TRPs. Spatial relation information for the SRS resource is given in FIG. 14. The spatialRelationInfo field in each SRS-Resource information element (IE) may comprise more than one beam information. Spatial info in the spatialRelationInfo field may be indicated or configured by TCI states. In this case, if more than one spatial relationship or more than 1 RS ID is indicated by a spatialRelationInfo field, the corresponding TCI state associated with the spatialRelationInfo field may include more than one spatial info or more than 1 RS ID.

The SRS-ResourceSet IE may indicate whether SRS-ResourceRep is ON or OFF. For the case of multiple TRPs, two or more TRPs may have the same setting or configuration of SRS-ResourceRep. It may be possible that two or more TRPs may have different settings on SRS-ResourceRep. This may be used so that two different BM processes are applied at TRPs. For example, one TRP may have a WTRU to apply fixed TX beam transmissions, such as for U-2, while another TRP may have a WTRU to apply multiple TX beam transmissions, such as for U-1 or U-3. In addition, one TRP may set the SRS-ResourceRep ON, while the other TRP may set the SRS-ResourceRep OFF. A SRS-ResourceRep item in SRS-ResourceSet may be configured for two Boolean values, each corresponding to a TRP.

To activate or trigger aperiodic SRS, the DCI indication may include a resource set activation, resource repetition flag, and may include UL beam indication. With two or more TRPs with a lead TRP, representing both TRPs, transmitting DCI to the WTRU, the resource set activation could be applied to either one of the TRPs or both TRPs. The resource repetition flag may be extended to either one of the TRPs or both TRPs. A 2-bit resource repetition flag, one per TRP, may be configured. In addition, the SRS request fields in the DCI may be extended from two bits to four bits, where every two bits represent the SRS resource set activation for a TRP.

When SRS-ResourceRep is OFF, via either higher layer, RRC, or L1 signaling, a set of UL TX beams may be indicated so that the WTRUs know how to perform UL TX beam sweeping. In a configuration, a single beam index is indicated in the triggering message and the WTRU may use the beams which are geographically close to the indicated single beam index or single beam. The range of WTRU TX beam sweeping may be pre-defined, configured, or additionally indicated. For example, 1-bit may be used to indicate a different range of WTRU TX beam sweeping, where a bit with value 0 indicates the X beams in WTRU TX beam sweeping centered with the indicated single beam, and a bit with value 1 indicates the Y beams in WTRU TX beam sweeping centered with the indicated single beam. In the case of multiple TRPs, a separate beam sweeping range information for each TRP may also be applied. These configurations may be considered as TRP specific beam selection for UL BM or TRP specific beam training, where SRS resource set(s) triggering and beam indication for SRS resources within configured/triggered SRS resource sets may be performed independently or jointly among multiple TRPs, as desired.

In addition to TRP specific beam selection for UL BM or TRP specific beam training, panel specific beam selection for UL BM or panel specific beam training may be configured. Implicit panel specific UL beam training may comprise when the network, jointly or separately by one or multiple gNBs or TRPs, triggers N (N>1) WTRU panels by triggering N SRS resource sets. Each SRS resource set may also be associated with a specific WTRU panel.

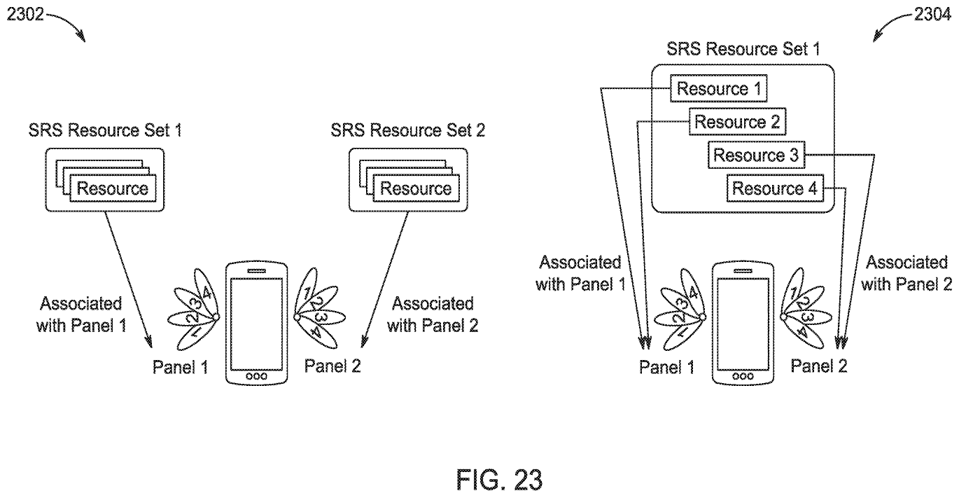

FIG. 23 illustrates an example of panel specific SRS association. A SRS resource set 1 may be associated with WTRU panel 1 and SRS resource set 2 may be associated with WTRU panel 2 in 2302. When any one of the two resource sets or both are triggered, such as through L1 or DCI signaling, or activated, such as through layer 2, MAC-CE, higher layer, or RRC signaling, a corresponding WTRU panel(s) may be used to perform beam training.

A network may trigger N>1 panels by triggering 1<=M<N SRS resource sets. Each SRS resource may be associated with a specific WTRU panel. In 2304, SRS resource set 1 may include SRS resource 1 and 2 that may be associated with WTRU panel 1 and SRS resource 3 and 4 may be associated with WTRU panel 2. When the SRS resource set 1 is triggered, such as by L1 or DCI signaling, or activated, such as by layer 2, MAC-CE, higher layer, or RRC signaling, both WTRU panel 1 and 2 may perform beam training. If the total number of SRS resources in one SRS resource set is unable to cover the total number of UL TX beams to be trained from all related WTRU panels, the number of triggered SRS resource sets may be increased or the value of M may be in the range of [1, N].

The network may trigger N>1 panels by following the ID or ordering of the triggered N SRS resource sets. Instead of each triggered SRS resource set associated with a specific WTRU panel, the ordering of the triggered sets or the ID of each triggered set may represent the associated WTRU panels. For example, if SRS resource set 1 and 2 are triggered and the panel association is not present in higher layer parameter or triggering message, SRS resource set 1 may be applied to WTRU panel 1, and SRS resource set 2 may be applied to WTRU panel 2. If SRS resource set 2 and 3 are triggered, the first set 2 may be applied to WTRU panel 1 and second set 3 may be applied to WTRU panel 2. To differentiate the ordering or set ID based panel selection, an additional field or flag may be configured or indicated in a higher layer message or lower signaling message to indicate whether ordering or set ID based panel selection is applied. A default rule may also be utilized. For example, if there is no flag information, the WTRU may determine that ordering of triggered SRS resource sets is used for panel selection by default.

In explicit panel specific UL beam training, a network may trigger N>1 WTRU panels by specifying panel indications or identifications ID(s) along with triggered SRS resource sets. The panel ID(s) may be configured in higher layer parameters associated with each configured SRS resource set, or dynamically included with each SRS triggering message, such as in one or multiple fields within a DCI.

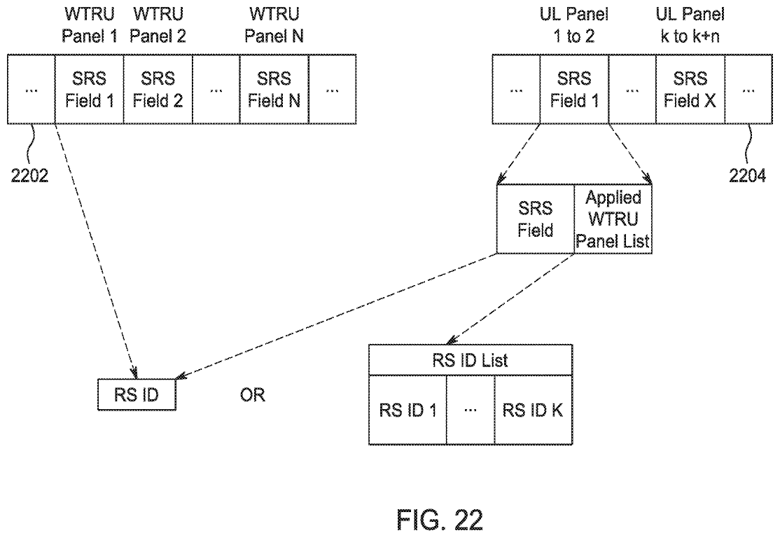

If multiple WTRU panels are configured or triggered to perform UL beam training, the panel ID associated with each triggered or configured SRS resource set may be jointly or independently indicated. FIG. 22 illustrates an example of independent physical uplink shared channel (PUSCH) beam indication and joint PUSCH beam indication, where SRS field, to indicate a SRS resource ID, may be replaced by an extended SRS request field, to indicate one or multiple SRS resource set IDs.

Once selection of WTRU panels is determined explicitly or implicitly, the beams to be trained within each selected panel may be determined using any of the examples herein. High layer parameters, spatialRelationInfo field, TCI state associated with each SRS resource, which may be RRC configured, L1 indicated, DCI indicated, layer 2 activated, or MAC-CE activated, resource ID ordering, or a beam range for beam training may be utilized for panel or beam determination.

FIG. 27 is a procedure for determining triggered WTRU panels and beams for UL BM. A WTRU may receive a configuration of SRS resources and an association with Panel ID(s). A WTRU may receive a SRS trigger in a DCI (2702), triggering one or multiple SRS resource sets. The triggered SRS resource sets may trigger one or multiple WTRU panels for a single TRP or multiple TRPs, and one beam, such as for U-2 procedure, or multiple beams, such as for U-3 procedure, within each triggered WTRU panel. The SRS trigger DCI may comprise additional fields such as repetition, Beam ID, or panel ID(s) (2704) for WTRU panel or beam determination.

To determine the triggered WTRU panels (2706), in an explicit operation, the DCI may comprise a list of triggered WTRU panel IDs. In an implicit operation, during SRS configuration, a WTRU may be configured with one or multiple SRS resource sets, where each resource set may be associated with one WTRU panel or each resource may be associated with one WTRU panel. In either case, when any one SRS resource set is triggered, a WTRU may determine the triggered WTRU panels from the associations of each triggered resource set or resource.

A WTRU may determine triggered WTRU panels by following the ordering of the triggered SRS resource sets. For example, the first triggered SRS resource set X may indicate a triggered WTRU panel 1 and the second triggered SRS resource set Y indicates a triggered WTRU panel 2. For another example, the triggered SRS resource set ID indicates the WTRU panel ID such as set 1 indicates WTRU panel 1 and set 3 indicates WTRU panel 3.

To determine the sweeping beams for each triggered WTRU panel (2708), the repetition field may indicate whether a WTRU performs a U-2 or U-3 procedure. The beam ID field may comprise one or more DL RS IDs, such as SSBI or CRI, or UL RS IDs, such as SRI. If the beam ID field comprises DL RS ID, the beam range may be derived based on the last or prior DL beam measurement results. If beam ID field comprises an UL RS ID, the beam range may be derived based on the last or prior UL beam measurement results.

A beam sweeping range may be derived explicitly based on the geographical location to the indicated beam. For implicit determination, a range may be determined by a beam list. A WTRU may autonomously determine from the last or prior DL or UL beam measurement results using a rule set for a beam range. In a hybrid operation, RRC signaling may be utilized. The repetition and beam ID fields may be partly or all present in the DCI. For example, both fields may be part of DCI or configured as RRC parameters. When both WTRU panels and beams are determined, the WTRU can perform UL beam sweeping (2710).

A network device, gNB, TRP, or the like may perform UL BM and evaluate optimal beams based on beam quality metrics such as a higher value of signal-to-interference-plus-noise ratio (SINR), RSRP, reference signal received quality (RSRQ), L1-RSRP, L1-RSRQ, L1-SINR, or the like. The network element may then send the selected beam index to the WTRU via beam indication, such as SRI. SRI may comprise multiple SRI fields or an extension of the existing SRI field. SRI may also include explicit indication of a selected WTRU panel(s) or single SRS resource transmitted associated with multiple panels. Once a WTRU receives one or more beam indications, such as SRI from the network, the WTRU may perform multi-panel based PUSCH transmission (2712).

In the examples given herein, TRP specific beam training and panel specific beam training may be performed jointly or separately. For example, when a WTRU is connected with two or more TRPs, any one of the TRPs may perform panel specific beam training separately, or even perform beam training only on a single WTRU panel. Both TRPs may be configured to jointly perform UL beam training with one or multiple panels of the WTRU.

Antenna or panel capability for each WTRU may be different and dynamic. For interference avoidance, power saving, or congestion control, either the network or the WTRU may activate, deactivate, turn off, or turn on some of the WTRU panels. The WTRU panel capability information may be updated or synchronized with network as needed.

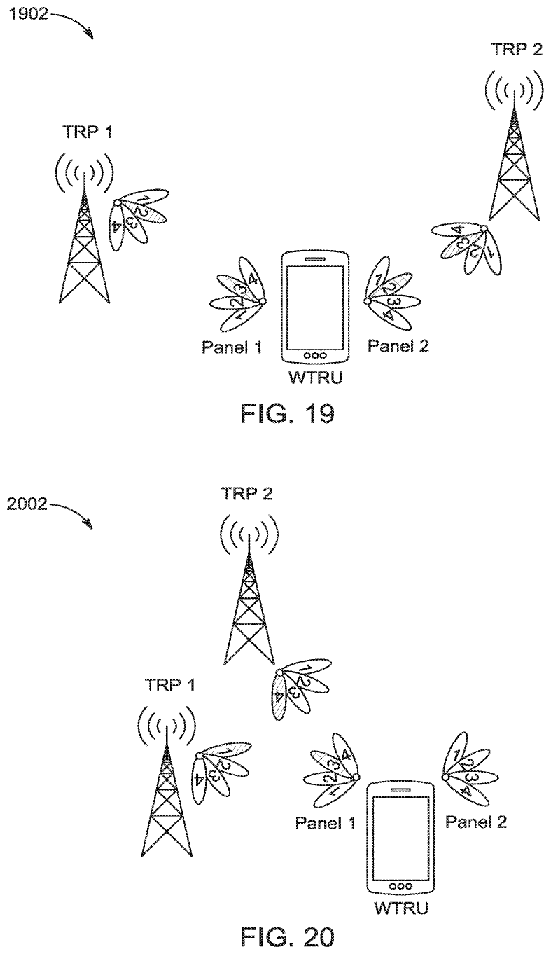

Once a WTRU utilizes one or multiple sets of SRS resources, one or multiple neighboring gNBs or TRPs may perform UL beam measurement. After SRS resource measurement at each neighboring TRP, optimal beam(s) may need to be indicated to the WTRU. To determine the optimal UL TX beam(s), independent indication, joint indication with maximum common quality, or joint indication with minimum interference may be configured. In FIG. 19, independent indication neighboring TRPs may measure the SRS transmissions independently and indicate the optimal beam for each TRP independently in 1902.

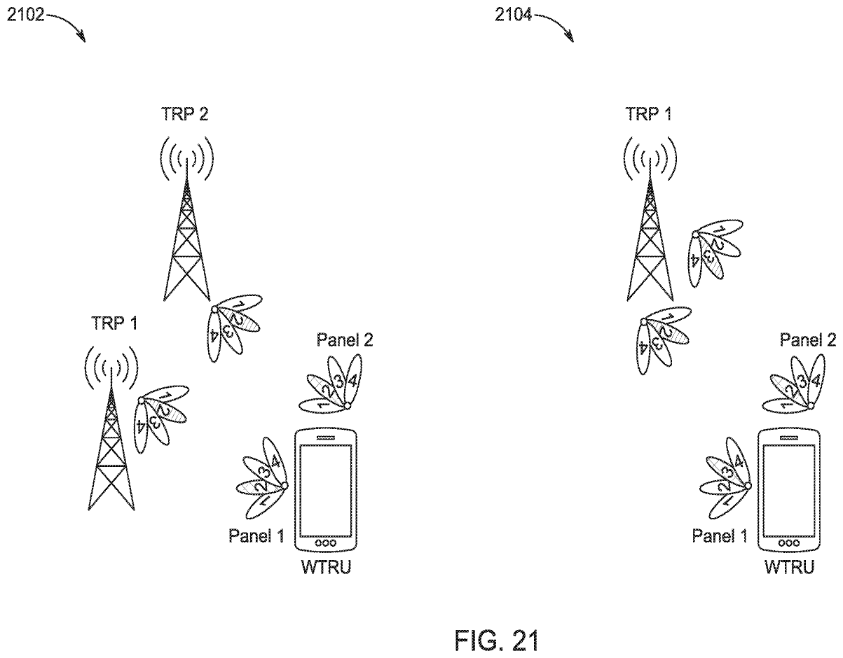

For joint indication with maximum common quality (case 2), neighboring TRPs may measure the SRS transmissions jointly. As shown in FIG. 20, the network may indicate the beam(s) which is optimal for both TRPs such that the beam(s) is robust enough due to quick recovery or simultaneous transmission in 2002. For joint indication with minimum interference (case 3), neighboring TRPs may measure SRS transmissions jointly. As shown in FIG. 21, the network may indicate a different optimal beam(s) for different TRPs or different panels of the same TRP. The optimal beam(s) may be selected such that the optimal beam(s) for one TRP or panel is the worst or least optimal beam for the other TRP or panel 2102 and 2104.

Independent indication and joint indication with minimum interference may be utilized for higher communication capacity and the beam pair links between a WTRU and one or multiple TRPs may be spatially separate enough to avoid interference. Joint indication with maximum common quality may be utilized for higher communication reliability and robustness and one common beam may be indicated to a WTRU since beam pair links between a WTRU and one or multiple TRPs may be with respect to the same UL TX beam.

For PUCCH communications, one or multiple PUCCH-Spatial-relation-info lists may be configured to a WTRU. For each configured PUCCH-Spatial-relation-info, new parameter(s) may be introduced to differentiate the UL TX beam used for a UL transmission from different WTRU panels and towards different TRP panels of a same TRP or different TRPs. For example, a high layer parameter, such as PUCCH-TRP, may be introduced to differentiate the beam pair links between a WTRU and different TRPs. For another example, one high layer parameter PUCCH-panel-ID may be introduced to indicate the beam used for a PUCCH transmitted from each WTRU panel.

One or multiple parameters may be configured to a WTRU. For example, if the mapping info between a specific WTRU panel and an associated TRP is known to a WTRU based on other configurations or signaling, one parameter may be enough to realize beam indication for PUCCH transmission for multi-TRP or multi-panel transmissions.

For each PUCCH-Spatial-relation-info, one or multiple SpatialRelationInfo IE(s) may be included. Each SpatialRelationInfo IE may be configured for different WTRU panels or TRPs or the same WTRU panels or TRPs. With multiple PUCCH-Spatial-relation-info lists configured to a WTRU, only one SpatialRelationInfo IE in each PUCCH-Spatial-relation-info may be used for UL transmission at one time instant and multiple SpatialRelationInfo IEs from different PUCCH-Spatial-relation-info lists may be used for UL transmission simultaneously. If multiple SpatialRelationInfo IEs are included in one PUCCH-Spatial-relation-info list, further activation signaling, such as MAC-CE or DCI, may be used to indicate spatial relation information for a PUCCH resource to one of the entries in a PUCCH-Spatial-relation-info list. If only one of the PUCCH-Spatial-relation-info lists is configured to a WTRU, it may indicate that multiple WTRU panels of a WTRU may share the same spatial relation information. SpatialRelationInfo IE(s) in the only one PUCCH-Spatial-relation-info may be WTRU panel specific.

For PUSCH indication, if the PUSCH transmissions from multiple antenna panels of a WTRU are transmitted from the same spatial domain transmission filter or UL TX beam, one SRI field may be utilized for PUSCH beam indication. If PUSCH transmissions from multiple antenna panels of a WTRU are transmitted from different spatial domain transmission filters or UL TX beams, PUSCH beam indication may be configured in various ways.

Referring again to FIG. 22, for independent PUSCH beam indication for different WTRU panels associated with one TRP or multiple TRPs, separate SRS fields are part of DCI signaling to independently indicate a beam used for PUSCH transmission for multi-TRP or multi-panel transmission 2202. In joint PUSCH beam indication 2204, one SRS field may be used to indicate one or multiple RS ID(s) or SRI fields associated with a list of WTRU or UL panels. In certain configurations, WTRU panel, UL panel, or UL WTRU panel may be interchangeable. For a PUSCH scheduled by DCI format 0_0, or the like on a cell, the WTRU may transmit PUSCH according to the spatial relation corresponding to the PUCCH resource with the lowest ID within the active UL BWP with respect to each WTRU panel.

UL BM or UL beam training may be performed by associating a SRS resource set with a WTRU panel. In this configuration, SRI may need explicit panel indication since a network measured SRS-based beam may have the same SRI from different SRS resource sets. If UL BM or UL beam training is performed by associating a SRS resource with a WTRU panel, panel information may not be needed. For example, in 2304, if a WTRU receives beam indication with SRI #2 and SRI #3, the WTRU may send PUSCH simultaneously from WTRU panel 1 and panel 2 in the next slots. The specific beams from panel 1 and panel 2 may be known to the WTRU as well since the WTRU itself decides which beam(s) are swept in the previous beam training process.

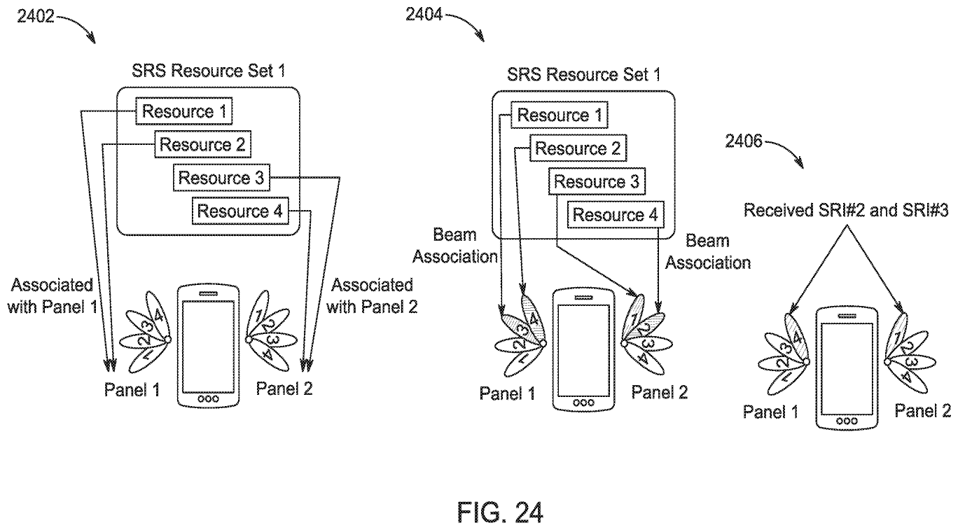

FIG. 24 illustrates an example of SRS resource association based beam indication for multi-panel PUSCH transmission. In 2402, four SRS resources may be associated with 2 WTRU panels. In 2404, according to higher layer parameters such as SRS-SpatialRelationInfo or DCI fields, each SRS resource may be associated with a specific beam within each WTRU panel. In 2406, when the WTRU receives extended SRI fields (SRI #2 and SRI #3) from the network, it may know that beam 3 from WTRU panel 1 and beam 1 from WTRU panel 2 are selected for future PUSCH transmissions. For simultaneous transmissions from multiple WTRU panels, the fields may indicate one of two different configurations: where different data from different panels are transmitted; or where the same data from different panels are transmitted. In FIG. 24, a WTRU may self determine a panel or beam with limited information.

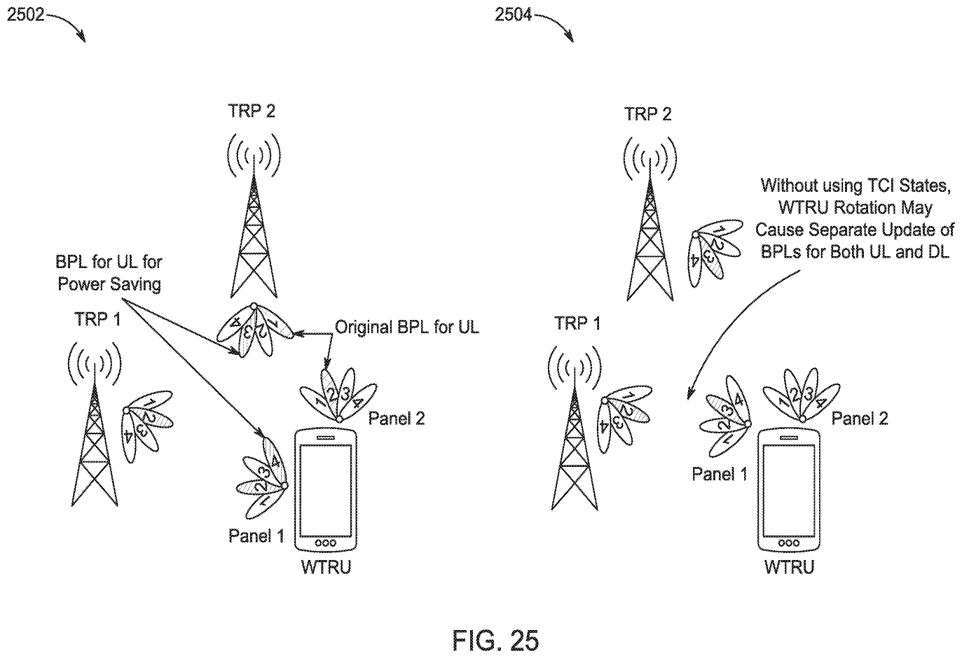

FIG. 25 illustrates an example of using TCI states for beam indication for a PUCCH or PUSCH. Panel specific UL beam selection for PUCCH or PUSCH may be based on DL RSs. Selection may also utilize TCI states. This may avoid SRS-based UL BM which may involve non-negligible beam sweeping delay, energy consumption, and signaling overhead. This configuration may also reduce the number of active WTRU panels at a time or reduce the overhead or signaling to achieve minimum number of WTRU active panels at a time. In 2502, an active BPL for DL transmission between TRP1 and the WTRU and an active BPL for UL transmission between TRP2 and the WTRU may be configured. If no simultaneous transmission from both WTRU panel 1 and panel 2 is desired, the WTRU may utilize one active panel at a time for power saving.

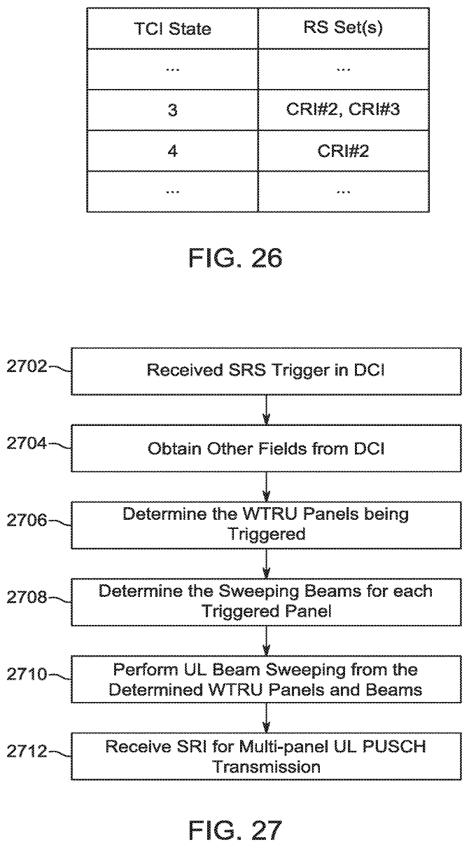

In 2502, beam 2 of WTRU panel 2 may be indicated for UL TX while beam 2 of WTRU panel 1 is indicated for DL RX. As shown in FIG. 26 with a table with examples of TCI entries for beam indication for PUCCH or PUSCH in relation with FIG. 25, if TCI state 3 is used for UL beam indication, CRI #3 in the TCI state 3 may indicate that beam 4 of WTRU panel 1 may be used for UL TX, which means both UL TX and DL RX may be from the same WTRU panel 1. As a result, WTRU panel 2 may be turned off or deactivated for power saving purposes. In 2504, when a WTRU rotates, both UL TX beam and DL RX beam indication may be needed. If TCI state 4 is used for UL beam indication, the corresponding UL TX beam may be automatically updated when DL beam indication is completed.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for a wireless transmit/receive unit (WTRU), the method comprising:
receiving configuration information for a plurality of downlink (DL) bandwidth parts (BWPs) and uplink (UL) BWPs;
activating a DL BWP and an UL BWP from a plurality of BWPs based on the configuration information;
evaluating beam measurements for a candidate DL BWP or a candidate UL BWP of the plurality of BWPs outside the activated DL BWP or the activated UL BWP;
based on indication of the evaluated beam measurements, dynamically changing at least one of the activated DL BWP or the activated UL BWP to the candidate DL BWP or the candidate UL BWP.
